(19) United States
(12) Patent Application Publication
(10) Pub. No.: US 2022/0315786 A1
(43) Pub. Date: Oct. 6, 2022

(54) Ink Set And Recording Method

(71) Applicant: Seiko Epson Corporation, Tokyo (JP)

(72) Inventors: Yuta ASAKAWA, Azumino (JP); Ippei OKUDA, Shiojiri (JP); Mitsuaki KOSAKA, Minowa (JP)

(21) Appl. No.: 17/705,692

(22) Filed: Mar. 28, 2022

(30) Foreign Application Priority Data
Mar. 29, 2021 (JP) 2021-054997

(51) Int. Cl. C09D 11/40; C09D 11/54; C09D 11/38; C09D 11/322; C09D 11/033; C09D 11/037; C09D 11/107; B41M 7/00; B41M 5/00

(52) U.S. Cl. CPC C09D 11/40; C09D 11/54; C09D 11/38; C09D 11/322; C09D 11/033; C09D 11/037; C09D 11/107; B41M 7/0018; B41M 5/0023

(57) ABSTRACT

An ink set includes a treatment liquid containing an aggregating agent and an ink composition, and the ink composition is a water-based ink containing a pigment dispersed by a pigment dispersant or a self-dispersible pigment; a water-dispersible resin; and a maleic acid-based resin which is a water-soluble resin.

The present application is based on, and claims priority from JP Application Serial Number 2021-054997, filed Mar. 29, 2021, the disclosure of which is hereby incorporated by reference herein in its entirety.

### BACKGROUND

### 1. Technical Field

The present disclosure relates to an ink set and a recording method.

### 2. Related Art

Since an ink jet method is able to form an image having a high quality on a recording medium, heretofore, various technical developments have been carried out. For example, besides a development of a recording apparatus using an ink jet method, developments of an ink composition and an ink set used for the above recording apparatus have also been actively performed.

For example, in order to control an aggregation property of a dispersion component contained in an ink composition, the use of a reaction liquid has also been studied. For example, JP-A-2018-154014 has disclosed that in order to obtain an image having a high image quality, a reaction liquid containing an aggregating agent is allowed to function on an ink composition containing a pigment and a wax as dispersions.

When a reaction liquid is contained in an ink set, for example, a function to rapidly fix an ink on a recording medium and/or a function to suppress gathering of ink dots may be expected by the reaction liquid. In addition, when components contained in an ink composition are each in a dispersion state, the reaction liquid may also be expected to have a function to make an image quality of an image to be obtained more preferable by aggregating the dispersion components.

As typical dispersion components in the ink composition, for example, although a pigment and resin particles may be mentioned, aggregation properties of those dispersion components are different from each other in many cases. For example, the resin particles have different aggregation properties depending on their types and have a relatively low aggregation property compared to those of the other dispersion components in many cases. Hence, the resin particles are not likely to receive the function of an aggregating agent in some cases, and as a result, the aggregation may not be sufficiently performed and/or an aggregation rate may become insufficient in some cases. Hence, aggregation irregularity may be generated in an image and/or an abrasion resistance thereof may be degraded in some cases.

### SUMMARY

According to an aspect of the present disclosure, there is provided an ink set comprising: a treatment liquid containing an aggregating agent; and an ink composition, and the ink composition is a water-based ink containing a pigment dispersed by a pigment dispersant or a self-dispersible pigment; a water-dispersible resin; and a maleic acid-based resin which is a water-soluble resin.

According to another aspect of the present disclosure, there is provided a recording method using the ink set described above, and the method comprises: an ink adhesion step of adhering the ink composition to a recording medium; and a treatment liquid adhesion step of adhering the treatment liquid to the recording medium.

### BRIEF DESCRIPTION OF THE DRAWINGS

FIG. 1 is a schematic view showing one example of an ink jet recording apparatus used in a recording method of an embodiment.

FIG. 2 is a schematic view of a carriage and its vicinity of one example of the ink jet recording apparatus used in the recording method of the embodiment.

FIG. 3 is a block diagram of one example of the ink jet recording apparatus used in the recording method of the embodiment.

FIG. 4 is a flowchart showing one example of a process performed for recording by the ink jet recording apparatus used in the recording method of the embodiment.

### DESCRIPTION OF EXEMPLARY EMBODIMENTS

Hereinafter, embodiments of the present disclosure will be described. The following embodiments are used to explain examples of the present disclosure. The present disclosure is not limited to the embodiments described below and also includes various types of modified embodiments to be performed without departing from the scope of the present disclosure. In addition, all compositions to be described below are not always required to be essential compositions of the present disclosure.

In this specification, “(meth)acryl” indicates acryl or methacryl, and “(meth)acrylate” indicates acrylate or methacrylate.

### 1. Ink Set

An ink set according to this embodiment includes a treatment liquid containing an aggregating agent and an ink composition. The ink composition described above is a water-based ink containing a pigment dispersed by a pigment dispersant or a self-dispersible pigment; a water-dispersible resin; and a maleic acid-based resin which is a water-soluble resin.

The ink set includes as a set, an ink composition and a treatment liquid to be used for recording. The ink composition and the treatment liquid included in the ink set may be received in separate liquid containers or in an integral liquid container.

The ink set includes at least one (one type) ink composition and at least one (one type) treatment liquid. At least two ink compositions and/or at least two treatment liquids may be included in the ink set.

### 1.1. Ink Composition

The ink composition is a water-based ink containing a pigment dispersed by a pigment dispersant or a self-dispersible pigment; a water-dispersible resin; and a maleic acid-based resin which is a water-soluble resin.

### 1.1.1. Pigment

The ink composition contains a pigment dispersed by a pigment dispersant or a self-dispersible pigment. As the pigment, for example, an inorganic pigment, such as a carbon black or a titanium white, and/or an organic pigment may be used.

As the inorganic pigment, for example, a carbon black (C.I. Pigment Black 7), such as a furnace black, a lamp black, an acetylene black, or a channel black; an iron oxide, a titanium oxide, a zinc oxide, or a silica may be used.

As the carbon black, for example, there may be mentioned No. 2300, 900, MCF88, No. 20B, No. 33, No. 40, No. 45, No. 52, MA7, MA8, MA100, or No2200B each manufactured by Mitsubishi chemical Co., Ltd.; or Color Black FW1, FW2, FW2V, FW18, FW200, S150, S160, or S170, Pretex 35, U, V, or 140U, or Special Black 6, 5, 4A, 4, or 250 each manufactured by Degussa AG. In addition, for example, Conductex SC, or Raben 1255, 5750, 5250, 5000, 3500, 1255, or 700 each manufactured by Columbia Carbon Inc. may also be mentioned. Regal 400R, 330R, or 660R, Mogul L, Monarch 700, 800, 880, 900, 1000, 1100, 1300, or 1400, or Elftex 12 each manufactured by Cabot Corporation may also be mentioned by way of example.

As the organic pigment, for example, there may be mentioned a quinacridone-based pigment, a quinacridonequinone-based pigment, a dioxazine-based pigment, a phthalocyanine-based pigment, an anthrapyrimidine-based pigment, an anthanthrone-based pigment, an indanthrone-based pigment, a flavanthrone-based pigment, a perylene-based pigment, a diketopyrrolopyrrole-based pigment, a perinone-based pigment, a quinophthalone-based pigment, an anthraquinone-based pigment, a thioindigo-based pigment, a benzimidazolone-based pigment, an isoindolinone-based pigment, an azomethine-based pigment, or an azo-based pigment.

As a concrete example of the organic pigment used in the ink composition, for example, the following may be mentioned.

As a cyan pigment, for example, C.I. Pigment Blue 1, 2, 3, 15:3, 15:4, 15:34, 16, 22, or 60; or C.I. Vat Blue 4 or 60 may be mentioned, and for example, one selected from the group consisting of C.I. Pigment Blue 15:3, 15:4, and 60 or a mixture containing at least two types thereof may be preferably mentioned.

As a magenta pigment, for example, C.I. Pigment Red 5, 7, 12, 48 (Ca), 48 (Mn), 57 (Ca), 57:1, 112, 122, 123, 168, 184, or 202, or C.I. Pigment Violet 19 may be mentioned, and for example, one selected from the group consisting of C.I. Pigment Red 122, 202, and 209, and C.I. Pigment Violet 19 or a mixture containing at least two types thereof may be preferably mentioned.

As a yellow pigment, for example, C.I. Pigment Yellow 1, 2, 3, 12, 13, 14C, 16, 17, 73, 74, 75, 83, 93, 95, 97, 98, 119, 110, 114, 128, 129, 138, 150, 151, 154, 155, 180, or 185 may be mentioned, and for example, one selected from the group consisting of C.I. Pigment Yellow 74, 109, 110, 128, and 138 or a mixture containing at least two types thereof may be preferably mentioned.

As an orange pigment, for example, C.I. Pigment Orange 36 or 43 or a mixture thereof may be mentioned. As a pigment used for a green ink, for example, C.I. Pigment green 7 or 36 or a mixture thereof may be mentioned.

The pigments mentioned above by way of example are examples of preferable pigments, and the pigments are not limited thereto. Those pigments may be used alone, or at least two types thereof may be used in combination.

The pigment may be used after being dispersed using a pigment dispersant. In addition, the pigment may be dispersedly used as a self-dispersible pigment after a pigment surface is oxidized or sulfonated with, for example, ozone, hypochlorite, or fuming sulfuric acid.

The pigment dispersant has a function to disperse a pigment in an ink composition. Although the pigment dispersant may be water soluble, a pigment dispersant not having a perfect water solubility is preferable, and the reason for this is believed such that since the dispersant is partially or totally adsorbed or bonded to the pigment so as to enhance a hydrophilic property of the surface of the pigment, the pigment can be dispersed. The type of pigment dispersant is not particularly limited.

The pigment dispersant is a high molecular weight compound, and as an example thereof, an acrylic-based resin or its salt may be mentioned, and as the acrylic-based resin, for example, there may be mentioned a poly(meth)acrylic acid, a (meth)acrylic acid-acrylonitrile copolymer, a (meth)acrylic acid-(meth)acrylate copolymer, a vinyl acetate-(meth)acrylate copolymer, a vinyl acetate-(meth)acrylic acid copolymer, a vinyl naphthalene-(meth)acrylic acid copolymer, a styrene-(meth)acrylic acid copolymer, a styrene-(meth)acrylate copolymer, a styrene-(meth)acrylic acid-(meth)acrylate copolymer, a styrene-α-methylstyrene-(meth)acrylic acid copolymer, or a styrene-α-methylstyrene-(meth)acrylic acid-(meth)acrylate copolymer. In addition, in this specification, a polymer having a skeleton derived from (meth)acrylic acid and having no skeleton derived from maleic acid or its analogous compound is called the acrylic-based resin.

In addition, as the pigment dispersant, for example, there may be mentioned a resin including a maleic acid-based resin, such as a styrene-maleic acid copolymer, a styrene-maleic anhydride copolymer, a vinyl naphthalene-maleic acid copolymer, or a vinyl acetate-maleate copolymer, or its salt; a crosslinked or non-crosslinked urethane-based resin or its salt; a poly(vinyl alcohol); or a vinyl acetate-crotonic acid copolymer or its salt. Although being a maleic acid-based resin, those polymers mentioned above are compounds each of which has a low water solubility and each of which aims to obtain a dispersibility of the pigment by adsorption thereto; hence, the polymers mentioned above are different from the maleic acid-based resin which will be described below.

In addition, besides the polymers as described above each formed from an acrylic-based monomer, the acrylic-based resin may be a copolymer formed from an acrylic-based monomer and another monomer. For example, an acrylic vinyl resin, that is, a copolymer using a vinyl-based monomer as the another monomer, is also called the acrylic-based resin. In addition, for example, among the styrene-based resins mentioned above, a copolymer between a styrene-based monomer and an acrylic-based monomer is also included in the acrylic-based resin. Furthermore, the acrylic-based resin also includes a salt and an ester compound thereof. In addition, in this specification, a copolymer between an acrylic-based monomer and a maleic acid or its derivative is classified in the maleic acid-based resin.

As a commercially available product of the pigment dispersant, for example, there may be mentioned X-200, X-1, X-205, X-220, or X-228 (manufactured by Seiko PMC Corporation); NOPCOSPERSE (registered trademark) 6100 or 6110 (manufactured by SAN NOPCO Limited); Joncryl 67, 586, 611, 678, 680, 682, or 819 (manufactured by BASF); DISPERBYK-190 (manufactured by BYK Japan KK); or N-EA137, N-EA157, N-EA167, N-EA177, N-EA197D, N-EA207D, or E-EN10 (manufactured by DKS Co., Ltd.).

As a commercially available product of an acrylic-based pigment dispersant, for example, there may be mentioned BYK-187, BYK-190, BYK-191, BYK-194N, or BYK-199 (manufactured by BYK Japan KK); or Aron A-210, A6114, AS-1100, AS-1800, A-30SL, A-7250, or CL-2 (manufactured by Toagosei Company, Limited).

As a commercially available product of an urethane-based pigment dispersant, for example, there may be mentioned BYK-182, BYK-183, BYK-184, or BYK-185 (manufactured by BYK Japan KK); TEGO Disperse 710 (manufactured by Evonic Tego Chemi); or Borchi (registered trademark) Gen 1350 (manufactured by OMG Borschers).

The pigment dispersant may be used alone, or at least two types thereof may be used in combination. A total content of the pigment dispersant with respect to 100 percent by mass of the ink is 0.1 to 30 percent by mass, preferably 0.5 to 25 percent by mass, more preferably 1 to 20 percent by mass, and further preferably 1.5 to 15 percent by mass. Since the content of the pigment dispersant is 0.1 percent by mass or more, a dispersion stability of the pigment can be secured. In addition, when the content of the pigment dispersant is 30 percent by mass or less, a viscosity of the ink composition can be decreased low.

In addition, the pigment dispersant more preferably has a weight average molecular weight of 500 or more. Since the pigment dispersant as described above is used, the odor is suppressed, and the dispersion stability of the pigment can be made more preferable.

A glass transition temperature (Tg) of the pigment dispersant is preferably 40° C. or more, more preferably 70° C. or more, and further preferably 90° C. or more. On the other hand, the Tg described above is preferably 120° C. or less, more preferably 110° C. or less, and further preferably 100° C. or less.

When the pigment is dispersed by the pigment dispersant, a ratio of the pigment to the pigment dispersant is preferably 10:1 to 1:10 and more preferably 4:1 to 1:3.

In addition, a volume average particle diameter (D50) of the pigment measured by a dynamic light scattering method is preferably 20 to 300 nm, more preferably 30 to 200 nm, and further preferably 40 to 100 nm.

Although a content of the pigment can be appropriately adjusted, the content described above is preferably 0.10 to 20.0 percent by mass, more preferably 0.20 to 15.0 percent by mass, even more preferably 1.0 to 10.0 percent by mass, and further preferably 2.0 to 5.0 percent by mass.

In the ink set of this embodiment, when the ink composition contains a pigment dispersed by a pigment dispersant, the pigment dispersant is preferably formed from an acrylic-based resin. Accordingly, the dispersibility of the pigment in the ink composition can be made more preferable.

### 1.1.2. Water-Dispersible Resin

The ink composition contains a water-dispersible resin. The water-dispersible resin functions, for example, as a so-called fixing resin to improve adhesion of components of the ink composition adhered to a recording medium. As the water-dispersible resin described above, for example, there may be mentioned a water-dispersible resin formed from an urethane-based resin, an acrylic-based resin (including a styrene-acrylic-based resin), a fluorene-based resin, an olefin-based resin, a rosin-modified resin, a terpene-based resin, an ester-based resin, an amide-based resin, an epoxy-based resin, a vinyl chloride-based resin, a vinyl chloride-vinyl acetate copolymer, or an ethylene-vinyl acetate-based resin. Those water-dispersible resins may be in the form of particles (resin particles) and are each frequently handled in the form of an emulsion. The water-dispersible resin may also be in the form of a powder. In addition, the water-dispersible resin may be used alone, or at least two types thereof may be used in combination.

The urethane-based resin is a generic name of a resin having an urethane bond. As the urethane-based resin, for example, a polyether type urethane resin having an ether bond in its main chain besides the urethane bond, a polyester type urethane resin having an ester bond in its main chain besides the urethane bond, and a polycarbonate type urethane resin having a carbonate bond in its main chain besides the urethane bond may also be used. As the water-dispersible resin of the urethane-based resin, a commercially available product may also be used, and for example, there may be mentioned Superflex 460, 460s, or 840, or E-4000 (trade name, manufactured by DKS Co., Ltd.); Resamine D-1060, D-2020, D-4080, D-4200, D-6300, or D-6455 (trade name, manufactured by Dainichiseika Color & Chemicals Mfg. Co., Ltd.); Takelac WS-6021 or W-512-A-6 (trade name, manufactured by Mitsui Chemicals Polyurethanes Inc.); Suncure 2710 (trade name, manufactured by Lubrizol); or Permarin UA-150 (trade name, manufactured by Sanyo Chemical Industries, Ltd.).

The acrylic-based resin is a generic name of a polymer obtained by polymerization using at least one acrylic-based monomer, such as (meth)acrylic acid or a (meth)acrylate, as one component, and for example, a resin obtained from an acrylic-based monomer or a copolymer between an acrylic-based monomer and a monomer different therefrom may be mentioned. For example, an acrylic-vinyl-based resin which is a copolymer between an acrylic-based monomer and a vinyl-based monomer may be mentioned. Furthermore, for example, a copolymer using a vinyl-based monomer such as styrene may also be mentioned.

As the acrylic-based monomer, for example, acrylamide or acrylonitrile may also be used. As a commercially available product of a water-dispersible resin using an acrylic-based resin as a raw material, for example, there may be used FK-854 (trade name, manufactured by Chuo Rika Kogyo Corporation); Movinyl 952B or 718A (trade name, manufactured by Nippon Synthetic Chemical Industry Co., Ltd.); or Nipol LX852 or LX874 (trade name, manufactured by Zeon Corporation).

Among those mentioned above, the styrene-acrylic-based resin is a copolymer obtained from a styrene monomer and an acrylic-based monomer, and for example, there may be mentioned a styrene-acrylic acid copolymer, a styrene-methacrylic acid copolymer, a styrene-methacrylic acid-acrylate copolymer, a styrene-α-methyl styrene-acrylic acid copolymer, or a styrene-α-methyl styrene-acrylic acid-acrylate copolymer. As a water-dispersible resin of the styrene-acrylic-based resin, a commercially available product may also be used, and for example, there may be used Joncryl 62J, 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, or 7610 (trade name, manufactured by BASF); Movinyl 966A or 975N (trade name, manufactured by Nippon Synthetic Chemical Industry Co., Ltd.); or Vinyblan 2586 (trade name, manufactured by Nisshin Chemical Industry Co., Ltd.).

The olefin-based resin is a resin having a structure derived from an olefin, such as ethylene, propylene, or butylene, and a known resin may be appropriately used. As a water-dispersible resin of the olefin-based resin, a commercially available product may also be used, and for example, Arrowbase CB-1200 or CD-1200 (trade name, manufactured by Unitika Ltd.) may be used.

As other examples of commercially available emulsions of the water-dispersible resin, for example, there may be mentioned Microgel E-1002 or E-5002 (trade name, styrene-acrylic-based resin emulsion, manufactured by Nippon Paint Co., Ltd.); Boncoat 4001 (trade name, acrylic-based resin emulsion, manufactured by DIC Corporation); Boncoat 5454 (trade name, styrene-acrylic-based resin emulsion, manufactured by DIC Corporation); Polysol AM-710, AM-920, AM-2300, AP-4735, AT-860, or PSASE-4210E (acrylic-based resin emulsion), Polysol AP-7020 (styrene-acrylic resin emulsion), Polysol SH-502 (vinyl acetate resin emulsion), Polysol AD-13, AD-2, AD-10, AD-96, AD-17, or AD-70 (ethylene-vinyl acetate resin emulsion), or Polysol PSASE-6010 (ethylene-vinyl acetate resin emulsion) (trade name, manufactured by Showa Denko K.K.); Polysol SAE1014 (trade name, styrene-acrylic-based resin emulsion, manufactured by Zeon Corporation); Saivinol SK-200 (trade name, acrylic-based resin emulsion, manufactured by Saiden Chemical Industry Co., Ltd.); AE-120A (trade name, acrylic resin emulsion, manufactured by JSR Corporation); AE373D (trade name, carboxy-modified styrene-acrylic resin emulsion, manufactured by Emulsion Technology Co., Ltd.); Seikadyne 1900W (trade name, ethylene-vinyl resin emulsion, manufactured by Dainichiseika Color & Chemicals Mfg. Co., Ltd.); Vinyblan 2682 (acrylic resin emulsion), Vinyblan 2886 (vinyl acetate-acrylic resin emulsion), or Vinylblan 5202 (acrylic acetate resin emulsion) (trade name, manufactured by Nisshin Chemical Industry Co., Ltd.); Elitel KA-5071S, KT-8803, KT-9204, KT-8701, KT-8904, or KT-0507 (trade name, polyester resin emulsion, manufactured by Unitika Ltd.); Hitech SN-2002 (trade name, polyester resin emulsion, manufactured by Toho Chemical Industry Co., Ltd.); Takelac W-6020, W-635, W-6061, W-605, or W-6021 (trade name, urethane-based resin emulsion, manufactured by Mitsui Chemicals & Polyurethanes Inc.); Superflex 870, 800, 150, 420, 460, 470, 610, or 700 (trade name, urethane-based resin emulsion, manufactured by DKS Co., Ltd.); Permarin UA-150 (urethane-based resin emulsion, manufactured by Sanyo Chemical Industries, Ltd.); Suncure 2710 (urethane-based resin emulsion, manufactured by Nippon Lubrizol); NeoRez R-9660, R-9637, or R-940 (urethane-based resin emulsion, manufactured by Kusumoto Chemicals, Ltd.); Adeka Bontigher HUX-380 or 290K (urethane-based resin emulsion, manufactured by ADEKA Corporation); Movinyl 966A or Movinyl 7320 (manufactured by Nippon Synthetic Chemical Industry Co., Ltd.); Joncryl 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, or 7610 (manufactured by BASF); NK Binder R-5HN (manufactured by Shin-Nakamura Chemical Co., Ltd.); Hydran WLS-210 (non-crosslinked polyurethane, manufactured by DIC Corporation); or Joncryl 7610 (manufactured by BASF).

When the water-dispersible resin is contained in the ink composition, a content thereof with respect to a total mass of the ink composition is, as a solid content, preferably 10 percent by mass or less, more preferably 7 percent by mass or less, and further preferably 5 percent by mass or less. Accordingly, an image having a sufficiently preferable friction fastness can be recorded.

When the ink composition contains the water-dispersible resin as the resin, a glass transition temperature (Tg) of the water-dispersible resin is preferably 40° C. or more, more preferably 50° C. or more, and further preferably 55° C. or more. On the other hand, the glass transition temperature described above is preferably 100° C. or less, more preferably 90° C. or less, and further preferably 80° C. or less. When the glass transition temperature Tg described above is in the range described above, an image having a superior friction fastness can be preferably recorded. The glass transition temperature can be confirmed by a differential scanning calorimetry (DSC).

In addition, when the ink composition contains as the resin, a water-dispersible resin in the form of particles, a volume average particle diameter of the particles of the water-dispersible resin is preferably 200 nm or less, more preferably 150 nm or less, and further preferably 100 nm or less. When the volume average particle diameter described above is in the range described above, the recording can be preferably performed with a superior ejection stability. The volume average particle diameter of the particles of the water-dispersible resin can be confirmed in a manner similar to that of the pigment.

The water-dispersible resin may have, in some cases, an aggregation property by the function of an aggregating agent, such as calcium propionate, depending on the skeleton of the resin forming the particles and the property of the functional group thereof. In the ink set of this embodiment, the water-dispersible resin may not have an aggregation property when being mixed with a calcium propionate water solution. When the water-dispersible resin has no aggregation property, the abrasion resistance of an image is likely to be made preferable, and even if the water-dispersible resin has no aggregation property, by an aggregation property of the maleic acid-based resin which will be described later, an image having a sufficient image quality can be obtained by the ink set of this embodiment. From the point described above, between the content of the water-dispersible resin and the content of the maleic acid-based resin, a preferable ratio as described below is present.

To have an aggregation property indicates the case in which when the aggregation property is evaluated by an evaluation method in Example which will be described below, a high reactivity is confirmed, or the reactivity is confirmed although not being high. In addition, to have no aggregation property indicates the case in which when the evaluation is performed by the same evaluation method as described above, no reactivity is confirmed.

The water-dispersible resin is preferably one of an acrylic-based resin, an urethane-based resin, and a polyolefin-based resin. In addition, a content of the water-dispersible resin in total with respect to the total mass of the ink composition is preferably, 0.5 to 20 percent by mass, more preferably 1 to 15 percent by mass, and further preferably 2 to 12 percent by mass. When the content of the water-dispersible resin in the ink composition is in the range described above, by the ink set, the abrasion resistance of an image to be obtained can be made more preferable.

Furthermore, although the water-dispersible resin is preferably an acrylic-based resin, when a silicone-acrylic-based resin and an urethane-based resin are used in combination, the abrasion resistance of an image tends to be further improved. However, in the case described above, since a clogging recovery property may be degraded in some cases, a content of the urethane-based resin with respect to the total mass of the ink composition is preferably set to 1 percent by mass or less.

### 1.1.3. Maleic Acid-Based Resin

The ink composition contains a maleic acid-based resin which is a water-soluble resin.

When the solubility is measured by the following method, the water-soluble resin is a resin having a solubility of more than 10 g with respect to 100 g of water at 20° C.

The solubility is obtained as described below. After a resin is dried at 105° C. for 2 hours, a predetermined amount of the resin, the weight of which reaches a constant value, is dissolved in 100 g of water at 20° C. and then stirred for 30 minutes. When an undissolved resin is not observed after the stirring, the resin is considered to be dissolved. As described above, when a predetermined amount of the resin is mixed with 100 g of water at 20° C. as described above, the maximum predetermined amount which is considered to be dissolved is used as the solubility.

The maleic acid-based resin is a high molecular weight compound having a structure derived from a maleic acid.

As the maleic acid, for example, there may be mentioned a compound having a structure in which carboxy groups are bonded to respective adjacent carbon atoms boned to each other by an ethylenic carbon-carbon double bond or a compound which is derived therefrom.

As a concrete example of the maleic acid, for example, maleic acid, maleic anhydride, fumaric acid, citraconic acid, citraconic anhydride, or mesaconic acid may be mentioned. As the maleic acid, a compound in which the carboxy groups bonded to the respective adjacent carbon atoms described above are cyclized with dehydration or esterified may also be used. A carboxy group forming a salt is also included in the carboxy group.

As the derivative described above, for example, a compound in which at least one of the carboxy groups is modified as described above or a compound in which the ethylene skeleton further has at least one substituent may also be mentioned.

Among the maleic acids, maleic acid or a maleic acid in which at least one of the carboxy groups is modified is preferable.

As the maleic acid-based resin, a resin in which the carboxy groups derived from a maleic acid are cyclized with dehydration or esterified may also be used. A carboxy group forming a salt is also included in the carboxy group.

The high molecular weight compound having a structure derived from a maleic acid may be a high molecular weight compound obtained by polymerization or copolymerization using at least a maleic acid.

The maleic acid-based resin may be a polymer formed from a maleic acid or a copolymer between a maleic acid and another monomer. As the another monomer in this case, for example, a vinyl monomer, such as styrene, vinyl naphthalene, or vinyl acetate, or an acrylic monomer, such as (meth)acrylic acid or (meth)acrylate, may be mentioned.

The maleic acid-based resin has a structure derived from a maleic acid and has carboxy groups or structures each derived from a carboxy group at adjacent carbon atoms. In addition, for example, when acrylic acid is polymerized by a generally known method, a so-called head-to-tail polymerization occurs, and hence, the carboxy groups are rarely disposed at adjacent carbon atoms from a statistical point of view. Hence, in a polymer formed from an acrylic acid, compared to the case of a polymerization of a maleic acid, the carboxy groups are rarely disposed side by side on a main carbon chain of the polymer. Accordingly, for example, by a nuclear magnetic resonance (NMR) method or the like, whether or not adjacent carboxy groups are derived from a maleic acid can be confirmed.

At least one of the carboxy groups of the maleic acid-based resin may be an esterified group. For example, the carboxy group described above may be esterified by a compound having a hydroxy group. The two carboxy groups of the structure derived from a maleic acid may be not esterified, one of them may be esterified, or both of them may be esterified.

In addition, when being not esterified, the carboxy group of the structure derived from a maleic acid may be present in the form of a carboxylic acid in a water-based ink composition or may be partially or fully neutralized with ammonia, an alkanolamine, or an alkylamine.

Since having many structures each derived from the carboxy groups of a maleic acid, the maleic acid-based resin has a water solubility. Hence, in a water-based ink composition, molecular chains of the maleic acid-based resin have spreadability. Accordingly, when the ink composition and the treatment liquid are mixed together, the maleic acid-based resin and the aggregating agent come into contact with each other at a higher probability. Hence, the maleic acid-based resin has a preferable aggregation property, and as a result, an image quality of an image obtained by using the ink set can be improved.

When one of the two carboxy groups of the structure derived from a maleic acid of the maleic acid-based resin is esterified, a water resistance of an image to be obtained tends to be improved. In addition, when the two carboxy groups of the structure derived from a maleic acid are not esterified, the water resistance of an image to be obtained tends to be degraded. By the degree of esterification, since the balance between a hydrophilic property and a hydrophobic property of the maleic acid-based resin can be adjusted, a storage stability of the ink composition can be made more preferable, and in addition, the water resistance of an image to be obtained can be further improved. For example, a styrene-maleic anhydride half ester copolymer salt is preferable in terms of the balance between a hydrophilic property and a hydrophobic property. The reason for this is estimated that since the esterified carboxy group has a high hydrophobic property, insolubilization and/or solid-liquid separation during the reaction is promoted.

In addition, when the maleic acid-based resin includes a structure derived from maleic anhydride, the anhydride is considered to be transformed into a carboxy group in water.

In addition, the maleic acid-based resin is a water-soluble resin and is preferably present in the form of a solution so as to be dissolved in water used as a solvent component of the ink, for example, without adsorbing to the pigment or the like in the ink composition. Accordingly, a more excellent aggregation property can be obtained.

When the ink contains a pigment dispersed by a pigment dispersant, the maleic acid-based resin described in this section is contained in the ink separately from the pigment dispersant.

The maleic acid-based resin shows an aggregation property by the function of an aggregating agent, such as calcium propionate which will be described later, depending on the skeleton, the number of the functional groups, and the property of the resin forming the particles. In the ink set of this embodiment, when being mixed with a calcium propionate water solution, the maleic acid-based resin shows an aggregation property. Because of the aggregation property of the maleic acid-based resin, an image having a sufficient image quality can be obtained by the ink set of this embodiment. From the point as described above, between the content of the water-dispersible resin and the content of the maleic acid-based resin, a preferable ratio as described later is present.

The maleic acid-based resin preferably has an acidic group, such as a carboxy group, a sulfonate group, or a phosphate group. That is, even when at least one of the carboxy groups derived from a maleic acid is present in the form of an acid or a salt, or even when all the carboxy groups derived from a maleic acid are esterified, an acidic group, such as a carboxy group, a sulfonate group, or a phosphate group, is preferably present in the form of an acid or a salt on the skeleton or the ester group. In addition, the acid group may be partially or fully neutralized with ammonia, an alkanolamine, or an alkylamine.

According to the maleic acid-based resin as described above, since the aggregation property thereof is made more preferable, the image quality of an image to be obtained can be further improved. In addition, according to this ink set, the dissolution of the maleic acid-based resin is further stabilized, and hence, the storage stability of the ink composition can be made more preferable.

A weight average molecular weight of the maleic acid-based resin is preferably 2,000 to 100,000, more preferably 5,000 to 60,000, and further preferably 10,000 to 50,000. When the weight average molecular weight described above is in the range described above, suppression of aggregation irregularity of an image to be obtained and improvement of the abrasion resistance thereof can be made more preferable. In addition, the ejection stability of the ink composition from an ink jet head is also preferable.

As a commercially available product of the maleic acid-based resin, for example, there may be mentioned SN Dispersant 5027 or 5029 (manufactured by San Nopco Limited); Sanspearl PS-8 (manufactured by Sanyo Chemical Industries, Ltd.); Malialim HKM-50A, 150A, AKM-0531, or SC-0505K, or Polyster OMA (manufactured by NOF Corporation); Demol P, EP, or ST, or Boise 520 or 521 (manufactured by Kao Corporation); Polity A550 (manufactured by Lion Corporation); Arastar 703S or Polymalon 1318, 351T, 385, 372, 375CB, 482, 482s, or 1329 (manufactured by Arakawa Chemical Industries, Ltd.); XIRAN 1440H, 2625H, 1000H, 2000H, or 3000H (manufactured by Polyscope); Isoban 104 (manufactured by Kuraray Co., Ltd.); or Florene G-700AMP or G-700DMEA (manufactured by Kyoeisha Chemical Co., Ltd.).

A content of the maleic acid-based resin in the ink composition with respect to the total mass of the ink composition is preferably 0.05 to 3.0 percent by mass, 0.05 to 2.5 percent by mass, even more preferably 0.1 to 1.5 percent by mass, further preferably 0.2 to 1.0 percent by mass, and particularly preferably 0.3 to 0.8 percent by mass. When the content described above is in the range described above, by the ink set, the effect of the aggregating agent of the treatment liquid can be significantly obtained, and an image having a high image quality can be formed.

### 1.1.4. Ratio Between Components, Total Content, Etc.

In the ink composition of the ink set of this embodiment, a preferable blending ratio between the water-dispersible resin and the maleic acid-based resin described above can be found. That is, a ratio (B/A) of a content (B) of the maleic acid-based resin to a content (A) of the water-dispersible resin is preferably 0.19 or less, more preferably 0.17 or less, even more preferably 0.15 or less, and further preferably 0.13 or less. In addition, the ratio described above is preferably 0.01 or more, more preferably 0.03 or more, and further preferably 0.05 or more.

When the ratio (B/A) is in the range described above, the abrasion resistance of an image to be formed can be made more preferable.

In addition, in the ink set, a total content of the water-dispersible resin and the maleic acid-based resin contained in the ink composition with respect to the total mass of the ink composition is preferably 0.05 to 5 percent by mass, more preferably 0.1 to 3 percent by mass, even more preferably 0.2 to 2 percent by mass, and further preferably 0.5 to 1.5 percent by mass.

Since the total content of the water-dispersible resin and the maleic acid-based resin is set in the range described above, an effect to suppress the aggregation irregularity of an image and an effect to enhance the abrasion resistance of the image can be more significantly obtained.

### 1.1.5. Water-Soluble Low Molecular Weight Organic Compound

The ink composition may contain a water-soluble low molecular weight organic compound. In this specification, the water-soluble low molecular weight organic compound is an organic compound having a solubility of more than 10 g with respect to 100 g of water at 20° C. and having a molecular weight of 500 or less. The molecular weight described above is preferably 400 or less and more preferably 300 or less.

In particular, a water-soluble low molecular weight organic compound having a standard boiling point of 150° C. to 250° C. may also be contained.

The solubility is obtained as described below. First, in an environment at 20° C., a predetermined amount of a compound is mixed with 100 g of water and then stirred for 30 minutes. After the stirring is performed, when neither phase separation nor sea-island structure is formed, a compound in the form of a liquid at ordinary temperature is considered to be dissolved. In addition, when an undissolved portion is not observed, a compound in the form of a solid at ordinary temperature is considered to be dissolved.

As described above, when a predetermined amount of an organic compound is mixed with 100 g of water at 20° C., the largest predetermined amount in the case in which the compound is considered to be dissolved is regarded as the solubility.

The water-soluble low molecular weight organic compound is preferably a compound having a melting point of 80° C. or less. When the melting point described above is in the range described above, the clogging recovery property and the ejection stability tend to be improved.

As the water-soluble low molecular weight organic compound, for example, a polyol may be mentioned. A polyol having a standard boiling point of 150° C. to 250° C. may be preferably contained.

When a polyol having a standard boiling point of 150° C. to 250° C. is contained, a moisture retaining property of the ink composition can be further enhanced, and when the ink set is used for an ink jet recording apparatus, the clogging recovery property of a nozzle of a recording head can be made more preferable.

The polyol is an organic compound having at least two hydroxy groups, and for example, an alkane derivative having at least two hydroxy groups and an alkylene ether having 4 carbon atoms or less and at least two hydroxy groups may be mentioned.

As an example of the polyol having a standard boiling point of 150° C. to 250° C., for example, there may be mentioned 1,2-ethanediol (ethylene glycol) (197° C.), 1,2-propanediol (propylene glycol) (188° C.), 1,2-butanediol (194° C.), 1,2-pentanediol (210° C.), 1,2-hexanediol (224° C.), 1,2-heptanediol (227° C.), 1,3-propanediol (210° C.), 1,3-butanediol (230° C.), 1,4-butanediol (230° C.), 2,3-butanediol (177° C.), 1,5-pentanediol (242° C.), 1,6-hexanediol (250° C.), 2-ethyl-2-methyl-1,3-propanediol (226° C.), 2-methyl-1,3-propanediol (214° C.), 2,2-dimethyl-1,3-propanediol (210° C.), 3-methyl-1,3-butanediol (203° C.), 3-methyl-1,5-pentanediol (250° C.), 2-methylpentane-2,4-diol (197° C.), diethylene glycol (245° C.), or dipropylene glycol (232° C.). In addition, the numerical value in the parentheses represents a standard boiling point. Those alkyl polyols may be used alone, or at least two types thereof may be used in combination.

As a glycol ether which is a polyol, for example, there may be mentioned ethylene glycol, diethylene glycol, triethylene glycol, a polyethylene glycol, propylene glycol, dipropylene glycol, or tripropylene glycol, some of those glycol ether compounds being already mentioned above.

The polyol is able to function primarily as a permeating solvent and/or a moisture retaining solvent. The polyalcohol tends to have a strong property as the moisture retaining solvent. In addition, some alkanediols have a strong property as the permeating solvent, and some alkanediols have a strong property as the moisture retaining solvent.

In the ink composition, the polyols described above may be used alone, or at least two types thereof may be used in combination.

As the water-soluble low molecular weight organic compound, the ink composition may contain one of an amide, a sulfur-containing solvent, and a cyclic ether. In particular, any one of an amide, a sulfur-containing solvent, and a cyclic ether each having a standard boiling point of 150° C. to 300° C. may be contained. When any one of an amide, a sulfur-containing solvent, and a cyclic ether each having a standard boiling point of 150° C. to 300° C. is contained, since the water-soluble low molecular weight organic compound is likely to function as a solubilizing agent for the water-dispersible resin, the particles of the water-dispersible resin are likely to be swelled and/or softened. Accordingly, the flatness of the surface of an image to be formed is further improved, and the abrasion resistance of the image can be made more preferable.

As the amide, a cyclic amide may be mentioned. As the cyclic amide, a lactam may be mentioned. As the lactam, for example, there may be mentioned 2-pyrrolidone [245° C.], 2-pyperidone [256° C.], ε-caprolactam [267° C.], N-methyl-ε-caprolactam [248° C.], N-cyclohexyl-2-pyrrolidone [290° C.], 1-methyl-2-pyrrolidone [202° C.], 1-ethyl-2-pyrrolidone [218° C.], 1-propyl-2-pyrrolidone [227° C.], 1-butyl-2-pyrrolidone [241° C.], 5-methyl-2-pyrrolidone [248° C.], succinimide [287° C.], or ω-heptalactam. Those amides are preferable since promoting film formation of the water-dispersible resin, and in particular, 2-pyrolidone is more preferable (the numerical value in the parentheses indicates a standard boiling point).

As the amide, a non-cyclic amide may also be mentioned. The non-cyclic amide is an amide having no ring structure in its molecule.

As the non-cyclic amide, for example, an N,N-dialkylamide may be mentioned. As the N,N-dialkylamide, for example, an N,N-dialkyl-alkylamide, an N,N-dialkyl-alkoxyalkylamide, or an N,N-dialkyl-acetoacetamide may be mentioned.

As the N,N-dialkyl-alkoxyalkylamide, a compound represented by the following formula (1) may be mentioned.

R¹—O—CH₂CH₂—(C═O)—NR²R³ (1)

In the above formula (1), R¹ represents an alkyl group having 1 to 4 carbon atoms, and R² and R³ each independently represent a methyl group or an ethyl group. The “alkyl group having 1 to 4 carbon atoms” may be a linear or branched alkyl group, and for example, a methyl group, an ethyl group, an n-propyl group, an iso-propyl group, an n-butyl group, a sec-butyl group, an iso-butyl group, or a tert-butyl group may be mentioned. The compound represented by the above formula (1) may be used alone, or at least two types thereof may be used in combination.

In addition, in the above formula (1), R¹ preferably represents a methyl group. In the above formula (1), the standard boiling point of a compound having a methyl group as R¹ is low as compared to that of a compound in which R¹ represents an alkyl group having 2 to 4 carbon atoms. Hence, in the above formula (1), when a compound having a methyl group as R¹ is used, a surface drying property of an adhesion region may be further improved in some cases.

As a function of the amide, for example, improvement in surface drying property and fixing property of the ink composition adhered to a low-absorbing recording medium may be mentioned. In particular, the compound represented by the above formula (1) has an excellent function to appropriately soften and/or dissolve a vinyl chloride-based resin. Hence, the compound represented by the above formula (1) is able to soften and/or dissolve a recording surface of a recording medium containing a vinyl chloride-based resin and enables the ink composition to permeate the inside of the recording medium. Since the ink composition permeates the recording medium as described above, the component of the ink composition is tightly fixed, and in addition, the surface of the ink composition is more likely to be dried. Hence, an image to be obtained is likely to have excellent surface drying property and fixing property.

As a concrete example of the non-cyclic amide of the amide having a standard boiling point of 150° C. to 300° C., for example, there may be mentioned N,N-dimethylacetoacetamide [220° C.], N,N-diethylacetoacetamide, N-methylacetoacetamide [279° C.], N,N-dimethylformamide [153° C.], N,N-diethylformamide, N,N-dimethylacetamide [165° C.], N,N-diethylacetamide, N,N-dimethylpropionamide, N,N-dimethylisobutyramide [175° C.], 3-methoxy-N,N-dimethylpropanamide [215° C.], 3-n-butoxy-N,N-dimethylpropionamide [252° C.], 3-methoxy-N,N-diethylpropionamide, 3-methoxy-N,N-methylethylpropionamide, 3-ethoxy-N,N-dimethylpropionamide, 3-ethoxy-N,N-diethylpropionamide, 3-ethoxy-N,N-methylethylpropionamide, 3-n-butoxy-N,N-diethylpropionamide, 3-n-butoxy-N,N-methylethylpropionamide, 3-n-propoxy-N,N-dimethylpropionamide, 3-n-propoxy-N,N-diethylpropionamide, 3-n-propoxy-N,N-methylethylpropionamide, 3-iso-propoxy-N,N-dimethylpropionamide, 3-iso-propoxy-N,N-diethylpropionamide, 3-iso-propoxy-N,N-methylethylpropionamide, 3-tert-butoxy-N,N-dimethylpropionamide, 3-tert-butoxy-N,N-diethylpropionamide, or 3-tert-butoxy-N,N-methylethylpropionamide.

As a sulfur-containing solvent having a standard boiling point of 150° C. to 300° C., for example, dimethyl sulfoxide [189° C.], tetramethylene sulfoxide [235° C.], diethyl sulfoxide, methylphenyl sulfoxide, 3-methylsulfolane [276° C.], sulfolane [285° C.], ethyl isopropyl sulfone [251° C.], ethyl methyl sulfone, or dimethyl sulfone [248° C.] may be mentioned (the numerical value in the parentheses indicates a standard boiling point).

In addition, as a cyclic ether having a standard boiling point of 150° C. to 300° C., for example, 3-methyl-3-oxetanemethanol, 3-ethyl-3-oxetanemethanol [220° C.], 2-hydroxymethyl oxetane, isosorbide dimethyl ether [240° C.], tetrahydrofurfuryl alcohol [176° C.], solketal [192° C.], glycerol formal [192° C.], 1,4-dioxane-2,3-diol [259° C.], or dihydrolevoglucosenone [227° C.] may be mentioned (the numerical value in the parentheses indicates a standard boiling point).

When the water-soluble low molecular weight organic compound is used for the ink composition, a content thereof with respect to the total mass of the ink composition is preferably 5 to 40 percent by mass, more preferably 10 to 30 percent by mass, and further preferably 15 to 25 percent by mass. When the above content is in the range described above, the flatness of the surface of an image to be formed is further improved, and the abrasion resistance of the image can be made more preferable.

### 1.1.6. Other Components

The ink composition may also contain, besides the components described above, the following components.

### 1. Water

The ink composition may also contain water. The ink composition is a water-based ink. A water-based composition indicates a composition containing water as one primary solvent component. The water may be contained as a primary solvent component and is a component to be evaporated by drying. The water is preferably pure water, such as ion exchange water, ultrafiltration water, reverse osmosis water, or distilled water, or water, such as ultrapure water, in which ionic impurities are removed as much as possible. In addition, in the case in which water sterilized by UV radiation or addition of hydrogen peroxide is used, generation of fungi and bacteria can be preferably suppressed when the treatment liquid or the ink composition is stored for a long time. A content of the water with respect to the total mass of the ink composition is preferably 40 percent by mass or more, more preferably 45 percent by mass or more, even more preferably 50 to 98 percent by mass, and further preferably 55 to 95 percent by mass.

### 2. Organic Solvent

The ink composition may also contain an organic solvent. The organic solvent is a low molecular weight organic compound in the form of a liquid at ordinary temperature. Among the water-soluble low molecular weight organic compounds described above, a compound in the form of a liquid at ordinary temperature may also be used as the organic solvent.

The organic solvent may be a water-soluble low molecular weight organic compound or a compound other than the water-soluble low molecular weight organic compound. The organic solvent is preferably a water-soluble organic solvent. As a function of the organic solvent, for example, a function to improve wettability of the ink composition to a recording medium and/or a function to enhance the moisture retaining property of the ink composition may be mentioned. As the organic solvent, besides the compounds mentioned above, for example, an ester, an alkylene glycol ether, or a cyclic ester may be mentioned. In addition, the ink composition may contain, if needed, a polyol, such as trimethylolpropane or glycerin, having a standard boiling point of 280° C. or more.

The standard boiling point of the organic solvent contained in the ink composition is preferably 280.0° C. or less, more preferably 160.0° C. to 270.0° C., more preferably 180.0° C. to 260.0° C., and further preferably 200.0° C. to 250.0° C. When the organic solvent as described above is selected, for example, the abrasion resistance and the ejection stability are preferably likely to be further improved.

As the ester, for example, there may be mentioned a glycol monoacetate, such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, or methoxy butyl acetate; or a glycol diester, such as ethylene glycol diacetate, diethylene glycol diacetate, propylene glycol diacetate, dipropylene glycol diacetate, ethylene glycol acetate propionate, ethylene glycol acetate butyrate, diethylene glycol acetate butyrate, diethylene glycol acetate propionate, propylene glycol acetate propionate, propylene glycol acetate butyrate, dipropylene glycol acetate butyrate, or dipropylene glycol acetate propionate.

As the alkylene glycol ether, a monoether or a diether of an alkylene glycol may be used, and an alkyl ether is preferable. As a concrete example, for example, there may be mentioned an alkylene glycol monoalkyl ether, such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, or tripropylene glycol monobutyl ether; or an alkylene glycol dialkyl ether, such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, or tripropylene glycol dimethyl ether.

In addition, among the alkylene glycol ethers mentioned above, as compared to the monoether, the diether tends to easily dissolve or swell the treatment liquid or the water-dispersible resin in the ink composition and is more preferable since the abrasion resistance of an image to be formed tends to be improved. On the other hand, as compared to the diether, the monoether is preferable since the wettability of the ink composition is further improved.

As the cyclic ester, for example, there may be mentioned a cyclic ester (a lactone), such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ε-heptanolactone, γ-octanolactone, δ-octanolactone, ε-octanolactone, δ-nonalactone, ε-nonalactone, or ε-decanolactone, or a compound in which a hydrogen of a methylene group adjacent to a carbonyl group thereof is substituted by an alkyl group having 1 to 4 carbon atoms.

A total content of the organic solvents with respect to the total mass of the ink composition is preferably 40 percent by mass or less. On the other hand, the total content described above is preferably 5 percent by mass or more. Furthermore, the total content described above is preferably 5 to 40 percent by mass, more preferably 10 to 35 percent by mass, and further preferably 15 to 30 percent by mass. In particular, when the total content of the organic solvents with respect to the total mass of the ink composition is 30 percent by mass or less, while the ejection stability of the ink composition is made preferable, a wet abrasion resistance of an image can be made preferable.

### 3. Dye

The ink composition may also use a dye. As a water-soluble dye, for example, an acidic dye, a direct dye, a reactive dye, or a basic dye may be mentioned, and as a water-dispersible dye, for example, a dispersible dye, an oil soluble dye, or a sublimation dye may be mentioned.

### 4. Surfactant

The ink composition may also contain a surfactant. The surfactant has a function to decrease a surface tension of the ink composition so as to improve the wettability thereof to a recording medium or an underlayer. Among the surfactants, an acetylene glycol-based surfactant, a silicone-based surfactant, or a fluorine-based surfactant may be preferably used.

Although the acetylene glycol-based surfactant is not particularly limited, for example, there may be mentioned Surfynol 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, or DF110D (trade name, manufactured by Air Products & Chemicals); Olfine B, Y, P, A, STG, SPC, E1004, E1010, PD-001, PD-002W, PD-003, PD-004, EXP.4001, EXP.4036, EXP.4051, AF-103, AF-104, AK-02, SK-14, or AE-3 (trade name, manufactured by Nisshin Chemical Industry Co., Ltd.); or Acetylenol E00, EGOP, E40, or E100 (trade name, manufactured by Kawaken Fine Chemicals Co., Ltd.).

Although the silicone-based surfactant is not particularly limited, a polysiloxane-based compound may be preferably mentioned. Although the polysiloxane-based compound is not particularly limited, for example, a polyether modified organosiloxane may be mentioned. As a commercially available product of this polyether modified organosiloxane, for example, there may be mentioned BYK-306, BYK-307, BYK-333, BYK-341, BYK-345, BYK-346, or BYK-348 (trade name, manufactured by BYK Japan KK); or KF-351A, KF-352A, KF-353, KF-354L, KF-355A, KF-615A, KF-945, KF-640, KF-642, KF-643, KF-6020, X-22-4515, KF-6011, KF-6012, KF-6015, or KF-6017 (trade name, manufactured by Shin-Etsu Chemical Co., Ltd.).

As the fluorine-based surfactant, a fluorine modified polymer is preferably used, and as a concrete example, for example, BYK-3440 (manufactured by BYK Japan KK); Surflon S-241, S-242, or S-243 (trade name, manufactured by AGC SEIMI CHEMICAL CO., LTD.); or Ftergent 215M (manufactured by Neos Co., Ltd.) may be mentioned.

When the surfactant is contained in the ink composition, a plurality of surfactants may be contained. A content of the surfactant contained in the ink composition with respect to the total mass thereof is preferably 0.1 to 2.0 percent by mass, more preferably 0.2 to 1.5 percent by mass, and more preferably 0.3 to 1.0 percent by mass.

### 5. Additive

The ink composition may contain as the additive, for example, an urea, an amine, and/or a saccharoid. As the urea, for example, urea, ethyleneurea, tetramethylurea, thiourea, or 1,3-dimethyl-2-imidazolidinone may be mentioned, and a betaine (such as trimethylglycine, triethylglycine, tripropylglycine, triisopropylglycine, N,N,N-trimethylalanine, N,N,N-triethylalanine, N,N,N-triisopropylalanine, N,N,N-trimethylmethylalanine, carnitine, or acetylcarnitine) may also be mentioned.

As the amine, for example, diethanolamine, triethanolamine, or triisopropanolamine may be mentioned. The urea and the amine each may also be used to function as a pH adjuster.

As the saccharoid, for example, there may be mentioned glucose, mannose, fructose, ribose, xylose, arabinose, galactose, aldonic acid, glucitol (sorbit), maltose, cellobiose, lactose, sucrose, trehalose, or maltotriose.

### 6. Wax

The ink composition may contain a wax. Since having a function to impart lubricity to an image formed by the ink composition, for example, the wax can suppress peeling of the image. As a component to form the wax, for example, there may be mentioned a plant/animal wax, such as a carnauba wax, a candelilla wax, a beeswax, a rice wax, or a lanolin; a petroleum-based wax, such as a paraffin wax, a microcrystalline wax, a polyethylene wax, an oxidized polyethylene wax, or a petrolatum; a mineral-based wax, such as a montan wax or an ozokerite: a synthetic wax, such as a carbon wax, a Hoechst wax, a polyolefin wax, or a stearic acid amide; a natural/synthetic wax emulsion, such as an α-olefin/maleic anhydride copolymer; or a blended wax, and those waxes mentioned above may be used alone, or at least two types thereof may be used in combination.

As the wax, a commercially available product may be used without any modification, and for example, Nopcoat PEM-17 (trade name, manufactured by San Nopco Limited), Chemipearl W4005 (trade name, manufactured by Mitsui Chemicals Inc.), or AQUACER 515, 539, or 593 (trade name, manufactured by BYK Japan KK) may be mentioned.

### 7. Others

The ink composition used in the ink jet recording method according to this embodiment may further contain, if needed, components, such as an antiseptic agent/fungicide, an anti-rust agent, a chelating agent, a viscosity adjuster, an antioxidant, and/or an antifungal agent.

1.1.7. Physical Property and the like of Ink Composition

A viscosity of the ink composition at 20° C. is preferably 2 to 15 mPa·s. When the viscosity of the ink composition at 20° C. is in the range described above, an ink jet method can be further preferably used, and the ink composition can be more appropriately ejected from a nozzle. Accordingly, since flight bending and scattering of the ink composition can be further suppressed, the ink composition can be more preferably used by an ink jet recording apparatus.

The ink composition can be obtained by mixing the above components in an appropriate order and, if needed, by removing impurities using filtration or the like. As a mixing method of each component, for example, a method in which at least one material is charged in a container equipped with a stirring device, such as a mechanical stirrer or a magnetic stirrer, and then mixed by stirring is preferably used.

### 1.2. Treatment Liquid

The treatment liquid forming the ink set according to this embodiment contains an aggregating agent. Hereinafter, components to be contained in the treatment liquid will be described.

### 1.2.1. Aggregating Agent

The treatment liquid contains an aggregating agent to aggregate the components of the ink composition. The ink composition described above has an excellent aggregation property of a maleic acid-based resin by the aggregating agent of the treatment liquid, and hence, an image having an excellent image quality can be obtained.

Since working on the dispersibility of the components, such as the maleic acid-based resin, the pigment, and the water-dispersible resin, contained in the ink composition, the aggregating agent has a function to aggregate at least one of the dispersions thereof. The degree of the aggregation of the dispersion by the aggregating agent is changed depending on the types of aggregating agent and dispersion and can be adjusted. By the aggregation function as described above, for example, a color development property and/or the fixing property of an image can be enhanced.

Although the aggregating agent is not particularly limited, for example, a metal salt, an acid, or a cationic compound may be mentioned, and as the cationic compound, for example, a cationic resin (cationic polymer) or a cationic surfactant may be used. Among those mentioned above, as the metal salt, a polyvalent metal salt is preferable, and as the cationic compound, a cationic resin is preferable. As the acid, an organic acid or an inorganic acid may be mentioned, and an organic acid is preferable. Since the image quality, abrasion resistance, glossiness, and the like to be obtained are particularly excellent, the aggregating agent is preferably selected from a cationic resin, an organic acid, and a polyvalent metal salt.

Although the polyvalent metal salt is preferable as the metal salt, a metal salt other than the polyvalent metal salt may also be used. Among those aggregating agents, since having an excellent reactivity with the components contained in the ink, at least one selected from a metal salt and an organic acid is preferably used. In addition, among the cationic compounds, since being likely to be dissolved in the treatment liquid, a cationic resin is preferably used. In addition, at least two types of aggregating agents may be used in combination.

The polyvalent metal salt is a compound formed from a metal ion having at least two valences and an anion. As the metal ion having at least two valences, for example, an ion of calcium, magnesium, copper, nickel, zinc, barium, aluminum, titanium, strontium, chromium, cobalt, iron, or the like may be mentioned. Among the metal ions forming those polyvalent metal salts, since being excellent in aggregation property of the components of the ink, at least one of a calcium ion and a magnesium ion is preferable.

As the anion forming the polyvalent metal salt, an inorganic ion or an organic ion may be mentioned. That is, the polyvalent metal salt of the present disclosure is a salt formed from a polyvalent metal and an inorganic ion or an organic ion. As the inorganic ion as described above, for example, a chlorine ion, a bromine ion, an iodine ion, a nitrate ion, a sulfate ion, or a hydroxide ion may be mentioned. As the organic ion, an organic acid ion may be mentioned, and for example, a carboxylate ion may be mentioned.

In addition, the polyvalent metal compound is preferably an ionic polyvalent metal salt, and in particular, when the polyvalent metal salt is a magnesium salt or a calcium salt, the stability of the treatment liquid is made more preferable. In addition, as a counter ion of the polyvalent metal, either an inorganic acid ion or an organic acid ion may be used.

As a concrete example of the above polyvalent metal salt, for example, a calcium carbonate, such as a heavy calcium carbonate or a light calcium carbonate, calcium nitrate, calcium chloride, calcium sulfate, magnesium sulfate, calcium hydroxide, magnesium chloride, magnesium carbonate, barium sulfate, barium chloride, zinc carbonate, zinc sulfide, aluminum silicate, calcium silicate, magnesium silicate, copper nitrate, calcium acetate, magnesium acetate, aluminum acetate, calcium propionate, magnesium propionate, aluminum propionate, calcium lactate, magnesium lactate, or aluminum lactate may be mentioned. Those polyvalent metal salts may be used alone, or at least two types thereof may be used in combination. Among those mentioned above, since a sufficient solubility in water can be obtained, at least one of magnesium sulfate, calcium nitrate, aluminum lactate, and calcium propionate is preferable. In addition, those metal salts each have hydrated water in the form of a raw material.

As a metal salt other than the polyvalent metal salt, a monovalent metal salt, such as sodium salt or a potassium salt, may be mentioned, and for example, sodium sulfate or potassium sulfate may be mentioned.

As the organic acid, for example, there may be preferably mentioned a poly(meth)acrylic acid, formic acid, acetic acid, propionic acid, glycol acid, oxalic acid, malonic acid, malic acid, maleic acid, ascorbic acid, succinic acid, glutaric acid, adipic acid, fumaric acid, citric acid, tartaric acid, lactic acid, pyruvic acid, pyrrolidone carboxylic acid, pyrone carboxylic acid, pyrrole carboxylic acid, furan carboxylic acid, pyridine carboxylic acid, coumaric acid, thiophene carboxylic acid, nicotinic acid, or a derivative or a salt of one of those acids mentioned above. The organic acid may be used alone, or at least two types thereof may be used in combination. An organic acid salt also functioning as a metal salt is included in the metal salt mentioned above.

As the inorganic acid, for example, sulfuric acid, hydrochloric acid, nitric acid, or phosphoric acid may be mentioned. The inorganic acid may be used alone, or at least two types thereof may be used in combination.

As the cationic resin (cationic polymer), for example, a cationic urethane-based resin, a cationic olefin-based resin, a cationic amine-based resin, or a cationic surfactant may be mentioned.

As the cationic urethane-based resin, a commercially available product may be used, and for example, Hydran CP-7010, CP-7020, CP-7030, CP-7040, CP-7050, CP-7060, or CP-7610 (trade name, manufactured by DIC Corporation); Superflex 600, 610, 620, 630, 640, or 650 (trade name, manufactured by DKS Co., Ltd.); or Urethane Emulsion WBR-2120C or WBR-2122C (trade name, manufactured by Taisei Fine Chemical Co., Ltd.) may be used.

The cationic olefin-based resin is a resin having an olefin structural skeleton, such as ethylene or propylene, and a known resin may be appropriately selectively used. In addition, the cationic olefin-based resin may also be in the form of an emulsion in which the resin is dispersed in a solvent such as water or an organic solvent. As the cationic olefin-based resin, a commercially available product may be used, and for example, Arrowbase CB-1200 or CD-1200 (trade name, manufactured by Unitika Ltd.) may be mentioned.

As the cationic amine-based resin (cationic polymer), a resin having an amino group in its structure may be used, and a known resin may be appropriately and selectively used. For example, a polyamine resin, a polyamide resin, or a polyallylamine resin may be mentioned. The polyamine resin is a resin having an amino group in its main skeleton. The polyamide resin is a resin having an amide group in its main skeleton. The polyallylamine resin is a resin having a structure derived from an allyl group in its main skeleton.

In addition, as the cationic polyamine-based resin, for example, there may be mentioned Unisence KHE103L manufactured by Senka Corporation (hexamethylenediamine/epichlorohydrin resin, pH of 1%-water solution: approximately 5.0; viscosity: 20 to 50 (mPa·s); water solution at a solid content concentration of 50 percent by mass) or Unisence KHE104L (dimethylamine/epichlorohydrin resin, pH of 1%-water solution: approximately 7.0; viscosity: 1 to 10 (mPa·s); water solution at a solid content concentration of 20 percent by mass). Furthermore, as a concrete example of a commercially available product of the cationic polyamine-based resin, for example, there may be mentioned FL-14 (manufactured by SNF); Arafix 100, 251S, 255, or 255LOX (manufactured by Arakawa Chemical Industries, Ltd.); DK-6810, 6853, or 6885, WS-4010, 4011, 4020, 4024, 4027, or 4030 (manufactured by Seiko PMC Corporation); Papyogene P-105 (manufactured by Senka Corporation); Sumirez resin 650(30), 675A, 6615, or SLX-1 (manufactured by Taoka Chemical Co., Ltd.); Catiomaster (registered trademark) PD-1, 7, 30, A, PDT-2, PE-10, PE-30, DT-EH, EPA-SK01, or TMHMDA-E (manufactured by Yokkaichi Chemical Company Limited); or Jetfix 36N, 38A, or 5052 (manufactured by Satoda Chemical Industrial Co., Ltd.).

As the polyallylamine resin, for example, there may be mentioned a polyallylamine hydrochloride, a polyallylamineamide sulfate, an allylamine hydrochloride-diallylamine hydrochloride copolymer, an allylamine acetate-diallylamine acetate copolymer, an allylamine hydrochloride-dimethylallylamine hydrochloride copolymer, an allylamine-dimethylallylamine copolymer, a polydiallylamine hydrochloride, a polymethyldiallylamine hydrochloride, a polymethyldiallylamineamide sulfate, a polymethyldiallylamine acetate, a polydiallylmethylammonium chloride, a diallylamine acetate-sulfur dioxide copolymer, a diallylmethylethylammoniumethyl sulfur-sulfur dioxide copolymer, a methyldiallylamine hydrochloride-sulfur dioxide copolymer, a diallyldimethylammonium chloride-sulfur dioxide copolymer, or a diallydimethylammonium chloride-acrylamide copolymer.

As the cationic surfactant, for example, there may be mentioned a primary, a secondary, or a tertiary amine salt type compound, an alkylamine salt, a dialkylamine salt, an aliphatic amine salt, a benzalkonium salt, a quaternary ammonium salt, a quaternary alkylammonium salt, an alkylpyridinium salt, a sulfonium salt, a phosphonium salt, an onium salt, or an imidazolinium salt. As a concrete example of the cationic surfactant mentioned above, for example, there may be mentioned a hydrochloride or an acetate of laurylamine, palm amine, or rosin amine, lauryltrimethylammonium chloride, cetyltrimethylammonium chloride, benzyltributylammonium chloride, benzalkonium chloride, dimethylethyllaurylammonium ethyl sulfate, dimethylethyloctylammonium ethyl sulfate, trimethyllaurylammonium hydrochloride, cetylpyridinium chloride, cetylpyridinium bromide, dihydroxyethyllaurylamine, decyldimethylbenzylammonium chloride, dodecyldimethylbenzylammonium chloride, tetradecyldimethylammonium chloride, hexadecyldimethylammonium chloride, or octadecyldimethylammonium chloride. In addition, although functioning as the aggregating agent which will be described later, the cationic surfactant may be contained in the ink composition. However, the cationic surfactant is more preferably contained in the treatment liquid as the aggregating agent.

At least two types of the aggregating agents mentioned above may be used in combination. In addition, among the aggregating agents mentioned above, when at least one of the polyvalent metal salt, the organic acid, and the cationic resin is selected, since the aggregating function is made more preferable, an image having a higher image quality (in particular, a preferable color development property) can be formed.

A total content of the aggregating agent in the treatment liquid with respect to a total mass of the treatment liquid is, for example, 0.1 to 20 percent by mass, preferably 1 to 20 percent by mass and more preferably 2 to 15 percent by mass. In addition, when the aggregating agent is contained in the form of a solution or a dispersion, a content of the solid content is preferably in the range described above. When the content of the aggregating agent is 1 percent by mass or more, the aggregating agent is able to have a sufficient ability to aggregate the components contained in the ink. In addition, since the content of the aggregating agent is 30 percent by mass or less, the solubility and/or the dispersibility of the aggregating agent in the treatment liquid is made more preferable, and for example, a storage stability of the treatment liquid can be improved.

In addition, even when an organic solvent contained in the treatment liquid has a high hydrophobic property, in order to improve the solubility of the aggregating agent in the treatment liquid, as the aggregating agent, a compound having a solubility of 1 g or more with respect to 100 g of water at 25° C. is preferably used, and a compound having a solubility of 3 to 80 g is more preferably used.

### 1.2.2. Other Components

As long as not degrading the functions, the treatment liquid may contain, besides the aggregating agent, components, such as a water-soluble low molecular weight organic compound, an organic solvent, a surfactant, water, a wax, an additive, an antiseptic agent/fungicide, an antirust agent, a chelating agent, an antioxidant, and/or antifungal agent. Since the components described above are similar to those of the ink composition described above, details descriptions thereof will be omitted. The treatment liquid is preferably a water-based treatment liquid.

1.2.3. Physical Properties and the like of Treatment Liquid

A viscosity of the treatment liquid at 20° C. is preferably 2 to 15 mPa·s. When the viscosity of the treatment liquid at 20° C. is in the range described above, an ink jet method can be preferably used, and since the treatment liquid is appropriately ejected from a nozzle, and flight bending and scattering of the treatment liquid are suppressed, an ink jet recording apparatus can be preferably used.

The treatment liquid can be obtained by mixing the above components in an appropriate order and, if needed, by removing impurities using filtration or the like. As a mixing method of each component, for example, a method in which at least one material is charged in a container equipped with a stirring device, such as a mechanical stirrer or a magnetic stirrer, and then mixed by stirring is preferably used.

### 1.3. Other Compositions

As long as including the ink composition and the treatment liquid described above, the ink set of this embodiment may include at least one another ink composition. The ink set may include, for example, a plurality of the ink compositions or the treatment liquids described above and may further include at least one ink composition other than that described above, and in addition, for example, a clear ink composition containing no pigment may also be included.

### 1.4. Operational Effect

According to the ink set of this embodiment, since the maleic acid-based resin of the ink composition is likely to receive the function of the aggregating agent of the treatment liquid, when the treatment liquid and the ink composition are made to come into contact with each other to form an image, the aggregation irregularity of the image is not likely to be generated, and an image having a high image quality can be formed. Furthermore, since the ink composition contains the water-dispersible resin, the degradation of the abrasion resistance of the image caused by the water soluble property of the maleic acid-based resin can be suppressed, and in addition, by the synergetic effect between the maleic acid-based resin and the water-dispersible resin, the abrasion resistance of the image can be further improved.

### 2. Recording Method

A recording method of this embodiment uses the ink set described above and includes an ink adhesion step of ejecting the ink composition by an ink jet method to be adhered to a recording medium and a treatment liquid adhesion step of adhering the treatment liquid to the recording medium.

### 2.1. Recording Medium

A recording medium to form an image by the recording method according to this embodiment may have a recording surface which absorbs a liquid such as an ink composition and a treatment liquid or may have no recording surface which absorbs a liquid. Hence, the recording medium is not particularly limited, and for example, a liquid absorbing recording medium, such as paper or a cloth, a liquid low-absorbing recording medium, such as printing paper, or a liquid non-absorbing recording medium, such as a metal, a glass, a film, or a high molecular weight material, may be mentioned. However, an excellent effect of the recording method according to this embodiment becomes more significant when an image is recorded on a liquid low-absorbing medium or a liquid non-absorbing recording medium. That is, according to the recording method of this embodiment, even by a low-absorbing recording medium or a non-absorbing recording medium which is relatively liable to generate the aggregation irregularity, an image having a high image quality and a preferable abrasion resistance can be formed.

The liquid low-absorbing recording medium and the liquid non-absorbing recording medium indicate a recording medium hardly absorbing a liquid and a recording medium absorbing no liquid, respectively. From a quantitative point of view, the liquid non-absorbing recording medium or the liquid low-absorbing recording medium indicates a “recording medium having a water absorbing amount of 10 mL/m² or less from a contact start to a point of 30 msec^{1/2} by Bristow method”. This Bristow method is a most popular measurement method of a liquid absorption amount in a short time and has also been employed by Japan Technical Association of the Pulp and Paper Industry (JAPAN TAPPI). The details of the test method have been disclosed in Standard No. 51 “Paper and Paperboard-Liquid Absorption Test Method-Bristow Method”, JAPAN TAPPI PAPER AND PULP TEST METHODS, 2000. On the other hand, the liquid absorbing recording medium indicates a recording medium not corresponding to the liquid non-absorbing recording medium and the liquid low-absorbing recording medium. In addition, in this specification, the liquid low-absorbing recording medium and the liquid no-absorbing recording medium are simply called a low-absorbing recording medium and a non-absorbing recording medium, respectively, in some cases.

As the liquid non-absorbing recording medium, for example, there may be mentioned a film or a plate of a plastic, such as a poly(vinyl chloride), a polyethylene, a polypropylene, or a poly(ethylene terephthalate) (PET); a plate of a metal, such as iron, silver, copper, or aluminum; a metal plate or a plastic film formed by deposition of at least one of the above various metals; or a plate of an alloy, such as stainless steel or brass. In addition, for example, as the recording medium described above, a medium in which a plastic is coated on a substrate such as paper, a medium in which a plastic film is adhered to a substrate such as paper, or a plastic film having no absorbing layer (receiving layer) may also be mentioned. As the plastic described above, for example, there may be mentioned a poly(vinyl chloride), a poly(ethylene terephthalate), a polycarbonate, a polystyrene, a polyurethane, a polyethylene, or a polypropylene.

In addition, as the liquid low-absorbing recording medium, a recording medium having a surface on which a coating layer (receiving layer) to receive a liquid is provided may be mentioned. For example, as a recording medium using paper as a substrate, printing paper may be mentioned, and as a recording medium using a plastic film as a substrate, a recording medium in which, for example, a hydrophilic polymer is applied on a surface formed, for example, from a poly(vinyl chloride), a poly(ethylene terephthalate), a polycarbonate, a polystyrene, a polyurethane, a polyethylene, or a polypropylene or a recording medium in which particles formed of silica, titanium, or the like are applied together with a binder on the surface as described above may be mentioned.

Although the liquid absorbing recording medium is not particularly limited, for example, there may be mentioned regular paper, such as electrophotographic paper, having a high liquid permeability; ink jet paper (ink jet exclusive paper having an ink absorbing layer formed from silica particles or aluminum particles or having an ink absorbing layer formed from a hydrophilic polymer, such as a poly(vinyl alcohol) (PVA) or a poly(vinyl pyrrolidone) (PVP)); or art paper, coated paper, or cast paper, which has a relatively low liquid permeability and which is used for general offset printing. Furthermore, as the liquid absorbing recording medium, for example, a cloth or a non-woven cloth may also be mentioned.

In addition, the recording medium may be, for example, any one of a colorless transparent, a translucent, a colored transparent, a colored opaque, and an achromatic opaque medium. In addition, the recording medium itself may be either colored, translucent, or transparent.

### 2.2. Ink Adhesion Step

The ink adhesion step may be performed by any method as long as the ink composition is adhered while a recording head and a recording medium are relatively scanned. For example, the ink adhesion step is preferably performed by an ink jet method in which the recording head is used as an ink jet head, and the ink composition is ejected from the ink jet head. Accordingly, by a small apparatus, low-volume high-mix printing can be efficiently performed. Besides the ink jet method, the adhesion of the ink may be performed by an apologue printing method or the like.

The ink adhesion step can be easily performed by an ink jet recording apparatus. The details of the ink jet recording apparatus will be described later. An ink composition to be ejected from an ink jet head by an ink jet method and to be used for recording is called an ink jet ink composition.

### 2.3. Treatment Liquid Adhesion Step

The treatment liquid adhesion step is a step to adhere the treatment liquid to the recording medium. As a method to adhere the treatment liquid to the recording medium, one of a non-contact method and a contact method, such as an ink jet method, a coating method, a method of applying the treatment liquid to the recording medium by using various types of sprays, a method of applying the treatment liquid by immersing the recording medium therein, and a method of applying the treatment liquid to the recording medium by using a brush or the like, may be used, or at least two of the methods described above may be used in combination.

The treatment liquid adhesion step may be performed by an ink jet recording apparatus. Accordingly, by one ink jet recording apparatus, the treatment liquid and the ink composition can be preferably adhered to the recording medium. The details of the ink jet recording apparatus will be described later.

### 2.4. Other Steps

The recording method of this embodiment may further include, besides the ink adhesion step and the treatment liquid adhesion step described above, a heating step, a laminating step, and the like.

### 2.4.1. Heating Step

### (Primary Heating Step)

The recording method of this embodiment may further include a heating step of heating the composition adhered to the recording medium. Accordingly, an image having a high image quality and a preferable abrasion resistance can be obtained, and in addition, an effect of a high recording rate can be more significantly obtained. The heating step as described above is called a primary heating step. The primary heating step is a step to rapidly heat and dry the ink adhered to the recording medium. The ink is adhered to a heated recording medium, or the recording medium is heated at an early stage after the ink is adhered to the recording medium, and within approximately one second after an ink droplet is adhered to the recording medium, the heating is started on this ink droplet.

The primary heating step may include a step of heating the recording medium before the treatment liquid adhesion step and/or the ink adhesion step or during the adhesion step. The primary heating step may be performed by a drying method using a heating mechanism. As the drying method using a heating mechanism, a method (ventilation method) to send an ordinary temperature wind or a hot wind to the recording medium, a method (radiation method) to radiate radioactive rays (infrared rays or the like) generating heat to the recording medium, or a member (conduction method) to conduct heat to the recording medium by contact therewith may be mentioned, and at least two of the methods described above may be used in combination. When the primary heating step is performed, among those methods described above, the primary heating step is more preferably performed by the radiation method. The primary heating step using a heating mechanism is a step to immediately promote the drying of the composition adhered to the recording medium.

As described below, immediately before or after each composition is adhered to the recording medium, the primary heating step is preferably performed by a heating mechanism disposed at a position to which the composition is adhered. Accordingly, since the heating of an ink jet head is suppressed, a clogging resistance is made more excellent, and the ejection stability is expected to be improved.

An upper limit of a surface temperature of the recording medium in the primary heating step is preferably 45.0° C. or less, more preferably 43.0° C. or less, even more preferably 40.0° C. or less, further preferably 38.0° C. or less, even further preferably 35.0° C. or less, particularly preferably 32.0° C. or less, more particularly preferably 30.0° C. or less, and even more particularly 28.0° C. or less. On the other hand, a lower limit of the surface temperature described above is preferably 20.0° C. or more, more preferably 23.0° C. or more, even more preferably 25.0° C. or more, further preferably 28.0° C. or more, even further preferably 30.0° C. or more, and particularly preferably 32.0° C. or more.

The temperature described above is a surface temperature of a portion of a recording surface of the recording medium in the adhesion step to which the composition is adhered and is the maximum temperature of the adhesion step in a recording region. When the surface temperature described above is the above upper limit or less, it is more preferable in terms of suppression of clogging and high glossiness. When the surface temperature described above is the above lower limit or more, it is more preferable in terms of excellent durability of an image and excellent image quality thereof due to good spreadability of the composition.

The surface temperature of the recording medium during the adhesion can be increased relatively high by performing the primary heating step using a heating mechanism and can be decreased relatively low without performing the primary heating step.

When being performed, the primary heating step can be simultaneously performed with at least one of the above adhesion steps. When the primary heating step is simultaneously performed with the adhesion step, the surface temperature of the recording medium is preferably set to 43.0° C. or less and more preferably set to 40.0° C. or less.

### (Post-Heating Step)

The ink jet recording method according to this embodiment may further include, after the primary heating step is performed following each adhesion step described above, a post-heating step of heating the recording medium. The post-heating step is also called a secondary heating step. In the post-heating step, the heating is started approximately more than one second after all inks to be adhered to a certain region of the recording medium are adhered thereto.

The post-heating step may be performed using an appropriate heating device. The post-heating step is performed, for example, using an after heater (corresponding to a heating heater 5 in the following example of an ink jet recording apparatus 1). In addition, the heating device is not limited to a heating device equipped in the ink jet recording apparatus, and another drying device may also be used. Accordingly, since an image to be obtained can be dried and can be more sufficiently fixed, for example, a recorded matter can be rapidly placed in a ready to use state.

Although the temperature of the recording medium in this case is not particularly limited, for example, the temperature described above may be determined in consideration of a glass transition temperature (Tg) or the like of a resin component forming resin particles contained in the recorded matter. When the Tg of the resin component forming the water-dispersible resin or the wax is taken into consideration, the temperature of the recording medium described above may be set to be higher than the Tg of the resin component by 5.0° C. and more and preferably by 10.0° C. or more.

A surface temperature of the recording medium obtained by the heating in the post-heating step is 30.0° C. to 120.0° C., preferably 40.0° C. to 100.0° C., more preferably 50.0° C. to 95° C., and further preferably 70° C. to 90° C. The surface temperature of the recording medium obtained by the heating in the post-heating step is particularly preferably 80° C. or more. When the temperature of the recording medium is approximately in the range described above, film formation and planarization of the resin particles contained in the recorded matter can be performed, and in addition, an image to be obtained is dried and can be more sufficiently fixed.

### 2.4.2. Laminating Step

The recorded matter obtained by the recording method described above may be used after a laminating treatment is performed on a recorded surface of the recorded matter. A laminating step to perform lamination on the recording medium may be performed by film lamination such that a film is adhered on a recording surface of the recording medium to which the ink composition is adhered. In addition, although the laminating step is not particularly limited, after a known adhesive is adhered to a recorded surface of a recorded matter, a film may be adhered thereto, or a film to which an adhesive is adhered may be adhered to a recorded surface of a recorded matter. In addition, by extruding a molten resin obtained by melting a film onto a recorded surface of a recorded matter, a film may be formed on the recorded surface of the recorded matter. As a material of a film or the like used for lamination, for example, a resin made film may be used. Since the recorded matter is laminated, the abrasion resistance of the recorded matter is further improved, and in addition, when the recorded matter is handled in an inadequate manner such as being brought into contact with a solid material, the protection performance is preferably excellent. In addition, after the recorded matter and the film are adhered to each other, the adhesion therebetween is preferably made sufficient by compression performed with heating or at ordinary temperature.

### 2.4.3. Other Items

The treatment liquid adhesion step is preferably performed before the ink adhesion step is performed. Accordingly, the aggregating agent contained in the treatment liquid can be made to sufficiently function on the ink composition. In addition, the recording method of this embodiment may further include, if needed, at least one step of adhering at least one of the treatment liquid and the ink composition to the recording medium. In addition, the order and the number of those steps are not limited and, as needed, may be appropriately performed. In addition, in the case described above, the treatment liquid and each ink composition may be or may be not adhered to the same region of the recording medium. According to the recording method of this embodiment, an image having a high image quality and a preferable abrasion resistance can be formed.

### 3. Ink Jet Recording Apparatus

One example of an ink jet recording apparatus preferably used in the recording method according to this embodiment will be described with reference to the drawings. The ink jet recording apparatus includes an ink jet head to perform an ink adhesion step of an ink composition and a primary heating mechanism. In addition, the ink jet recording apparatus described above is able to perform the above recording method.

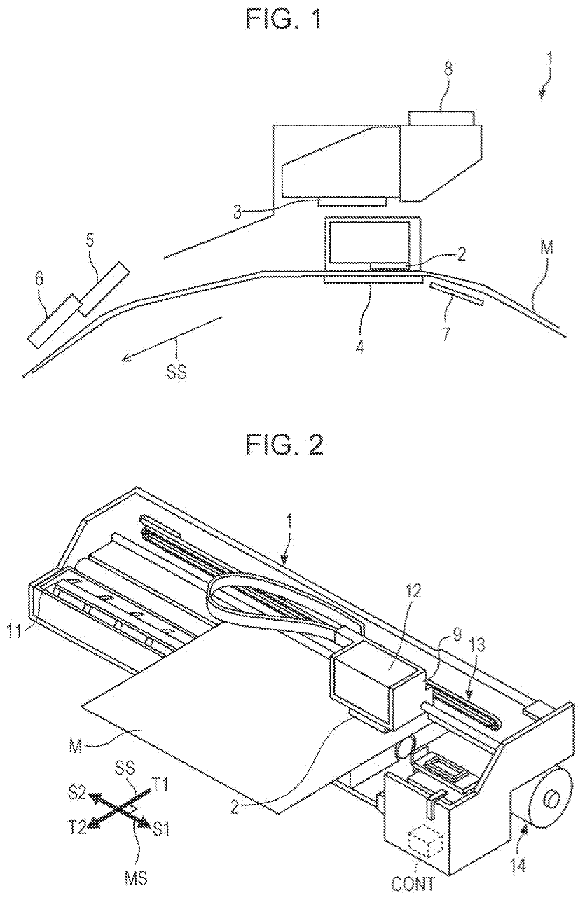

FIG. 1 is a cross-sectional view schematically showing an ink jet recording apparatus 1. FIG. 2 is a perspective view showing one example of the structure of a carriage and its vicinity of the ink jet recording apparatus 1 shown in FIG. 1. As shown in FIGS. 1 and 2, the ink jet recording apparatus 1 includes an ink jet head 2, an IR heater 3, a platen heater 4, a heating heater 5, a cooling fan 6, a pre-heater 7, a ventilation fan 8, a carriage 9, a platen 11, a carriage transfer mechanism 13, a transport device 14, and a control portion CONT. In the ink jet recording apparatus 1, all operations thereof are controlled by the control portion CONT shown in FIG. 2.

The ink jet head 2 has a structure to perform recording on a recording medium M by ejecting a treatment liquid and an ink composition from nozzles of the ink jet head 2 so as to be adhered thereto. In this embodiment, the ink jet head 2 is a serial type ink jet head and adheres the ink to the recording medium M by a plurality of scannings in a main scanning direction relative to the recording medium M. The ink jet head 2 is mounted on the carriage 9 shown in FIG. 2. The ink jet head 2 is scanned a plurality of times in the main scanning direction relative to the recording medium M by the operation of the carriage transfer mechanism 13 to transfer the carriage 9 in a medium width direction of the recording medium M. The medium width direction is the main scanning direction of the ink jet head 2. The scanning in the main scanning direction is also called a main scanning.

In addition, the main scanning direction is a direction in which the carriage 9 mounting the ink jet head 2 is transferred. In FIG. 1, the main scanning direction is a direction intersecting a sub-scanning direction which is a transport direction of the recording medium M shown by an arrow SS. In FIG. 2, the width direction of the recording medium M, that is, a direction represented by S1-S2, is a main scanning direction MS, and a direction represented by T1→T2 is a sub-scanning direction SS. In addition, by one scanning, the scanning is performed in the main scanning direction, that is, in one direction represented by an arrow S1 or an arrow S2. In addition, since the main scanning of the ink jet head 2 and the sub-scanning which is the transport of the recording medium M are repeatedly performed at least two times, the ink is recorded on the recording medium M. That is, the treatment liquid adhesion step and the ink adhesion step are performed by a plurality of main scannings in each of which the ink jet head 2 is transferred in the main scanning direction and a plurality of sub-scannings in each of which the recording medium M is transported in the sub-scanning direction intersecting the main scanning direction.

The cartridge 12 to supply the ink composition and the treatment liquid to the ink jet head 2 includes a plurality of independent cartridges. The cartridge 12 is detachably fitted to the carriage 9 mounting the ink jet head 2. In the cartridges, different types of ink compositions and treatment liquids are filled, and the ink compositions and the treatment liquids are supplied to individual nozzles from the cartridge 12. In addition, in this embodiment, although the case in which the cartridge 12 is fitted to the carriage 9 is shown by way of example, the cartridge 12 is not limited thereto and may be provided at a position other than the carriage 9 so that the ink compositions and the treatment liquids are each supplied to the nozzle by a supply tube not shown.

For the ejection by the ink jet head 2, a known method may be used. In this embodiment, a method to eject a liquid droplet using vibration of a piezoelectric element, that is, an ejection method to form an ink droplet by a mechanical deformation of a piezoelectric element, is used.

The ink jet recording apparatus 1 includes the IR heater 3 and the platen heater 4 each of which heats the recording medium M when the ink composition is ejected from the ink jet head 2. By the IR heater 3 or the platen heater 4, the primary heating step can be performed. Furthermore, in this embodiment, when the recording medium M is dried in the primary heating step, for example, the ventilation fan 8 which will be described later may be used.

In addition, when the IR heater 3 is used, the recording medium M can be heated using a method to radiate infrared rays from an ink jet head 2 side. Accordingly, although the ink jet head 2 is also liable to be simultaneously heated, compared to the case in which heating is performed from a rear surface of the recording medium M by the platen heater 4 or the like, the temperature can be increased without receiving the influence of the thickness of the recording medium M. In addition, there may be provided various types of fans (such as the ventilation fan 8) to dry the ink on the recording medium M by supplying a hot wind or a wind having the same temperature as that in the environment to the recording medium M.

When the treatment liquid or the ink composition ejected from the ink jet head 2 is adhered to the recording medium M, in order to dry the treatment liquid or the ink composition at an early stage, the platen heater 4 is able to heat the recording medium M at a position facing the ink jet head 2 with the platen 11 interposed therebetween. The platen heater 4 is able to heat the recording medium M by a conduction method, and in the recording method of this embodiment, the ink composition can be adhered to the recording medium M heated as described above (primary heating). Hence, the ink composition can be rapidly fixed on the recording medium M, and the image quality thereof can be improved.

The heating heater 5 dries and solidifies the treatment liquid or the ink composition adhered to the recording medium M, that is, the heating heater 5 is a secondary heating heater or a secondary drying heater. The heating heater 5 can be used in the post-heating step. Since the heating heater 5 heats the recording medium M on which an image is recorded, for example, moisture contained in the ink composition is more rapidly evaporated, and an ink film is formed by the resin contained in the ink composition. As described above, the ink film is tightly fixed or adhered onto the recording medium M so as to have an excellent film forming property, and an image having an excellent high image quality can be obtained in a short period.

The ink jet recording apparatus 1 may also include the cooling fan 6. After the ink composition recorded on the recording medium M is dried, the ink composition on the recording medium M is cooled by the cooling fan 6, and hence, an ink coating film can be formed to have an excellent adhesion onto the recording medium M.

In addition, the ink jet recording apparatus 1 may also include the pre-heater 7 to heat the recording medium M in advance before the ink composition is adhered to the recording medium M. Furthermore, the ink jet recording apparatus 1 may also include the ventilation fan 8 so as to efficiently dry the ink composition adhered to the recording medium M.

At a lower side of the carriage 9, there are provided the platen 11 to support the recording medium M, the carriage transfer mechanism 13 to transfer the carriage 9 relative to the recording medium M, and the transport device 14 which is a roller to transport the recording medium M in the sub-scanning direction. The operations of the carriage transfer mechanism 13 and the transport device 14 are controlled by the control portion CONT.

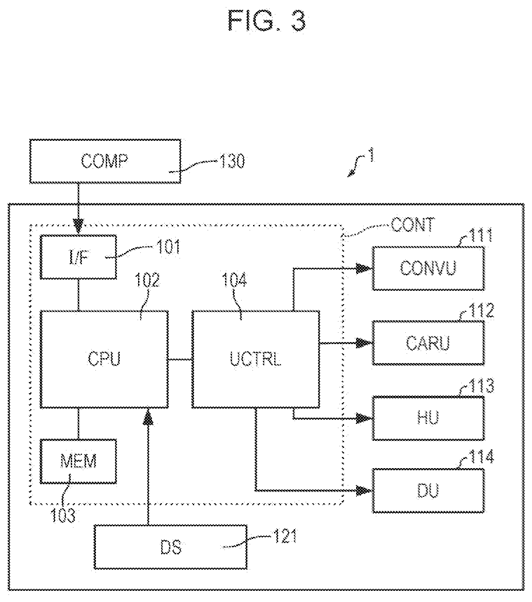

FIG. 3 is a functional block diagram of the ink jet recording apparatus 1. The control portion CONT is a control unit to control the ink jet recording apparatus 1. An interface portion 101 (I/F) functions to send and receive data between a computer 130 (COMP) and the ink jet recording apparatus 1. A CPU 102 is an arithmetic processing device to control the entire ink jet recording apparatus 1. A memory 103 (MEM) is to secure, for example, a region in which a program of the CPU 102 is stored and an operation region thereof. The CPU 102 controls individual units by a unit control circuit 104 (UCTRL). In addition, the status in the ink jet recording apparatus 1 is monitored by a detector group 121 (DS), and based on the detection result thereof, the control portion CONT controls the individual units.

A transport unit 111 (CONVU) controls the sub-scanning (transport) of the ink jet recording and in particular, controls a transport direction and a transport rate of the recording medium M. In particular, by controlling a rotation direction and a rotation rate of a transport roller driven by a motor, the transport direction and the transport rate of the recording medium M are controlled.

A carriage unit 112 (CARU) controls the main scanning (pass) of the ink jet recording and in particular, reciprocally transfers the ink jet head 2 in the main scanning direction. The carriage unit 112 includes the carriage 9 mounting the ink jet head 2 and the carriage transfer mechanism 13 to reciprocally transfer the carriage 9.

A head unit 113 (HU) controls an ejection amount of the ink composition from a nozzle of the ink jet head 2. For example, when the nozzle of the ink jet head 2 is driven by a piezoelectric element, the operation of the piezoelectric element of each nozzle is controlled. By the head unit 113, for example, a timing of each ink adhesion and a dot size of the ink composition are controlled. In addition, by combination of controls by the carriage unit 112 and the head unit 113, an adhesion amount of the ink composition per one scanning is controlled.

A drying unit 114 (DU) controls the temperatures of various types of heaters, such as the IR heater 3, the pre-heater 7, the platen heater 4, and the heating heater 5.

In the ink jet recording apparatus 1 described above, an operation in which the carriage 9 mounting the ink jet head 2 is transferred in the main scanning direction and a transport operation (sub-scanning) are alternately repeated. In this step, when each pass is performed, the control portion CONT controls the carriage unit 112 to transfer the ink jet head 2 in the main scanning direction and also controls the head unit 113 to eject a liquid droplet of the ink composition from a predetermined nozzle hole of the ink jet head 2 so as to adhere the liquid droplet to the recording medium M. In addition, the control portion CONT controls the transport unit 111 so that in the transport operation, the recording medium M is transported by a predetermined transport amount (feed amount) in the transport direction.

In the ink jet recording apparatus 1, since the main scanning (pass) and the sub-scanning (transport operation) are repeatedly performed, a recording region to which liquid droplets are adhered is gradually transported. Subsequently, by the heating heater 5, the liquid droplets adhered to the recording medium M are dried, so that an image is completed. Next, the recorded matter thus completed may be wound into a roll shape by a winding mechanism or may be transported by a flatbed mechanism.

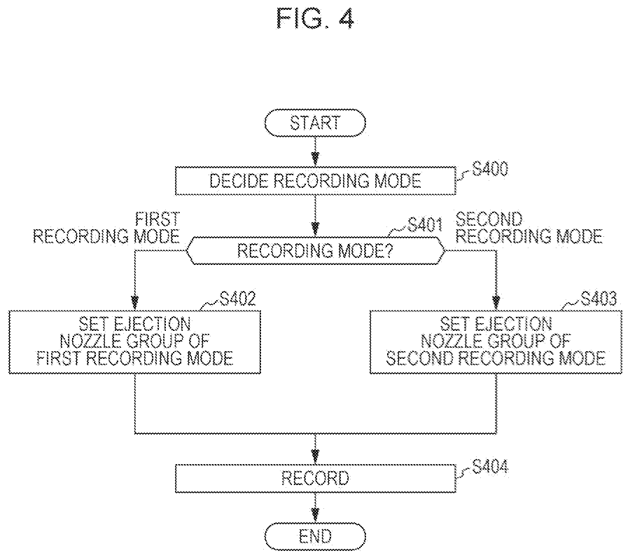

FIG. 4 is an example of a flowchart showing a processing to be performed when recording is performed by the ink jet recording apparatus. When the recoding is started, the control portion of the ink jet recording apparatus decides a recording mode in Step 400. The recording mode is a recording mode in which details of the recording, such as arrangement of nozzles, an ejection amount, an overlap printing mode, an operation of the ink jet head in the recording, an operation of the recording medium, and a control of the heating mechanism, are determined. In the details of the recording described above, the number of passes (the number of the main scannings performed on the same recording region of the recording medium) for the recording is also included.

The decision of the recording mode is performed by an input signal input from an external apparatus, such as a computer, to the ink jet recording apparatus or by input information of a user to a user input portion of the ink jet recording apparatus. In this case, the input signal from the external apparatus or the input information of the user may be information to directly designate the recording mode or may be information relating to the recording, such as information on type of recording medium on which recording is performed, designation of a recording rate, and/or designation of an image quality. In addition, the information relating to the recoding is not limited to those described above. In the latter case, the ink jet recording apparatus records in advance, for example, in the control portion thereof, correspondence information in which a recording mode corresponding to the information relating to the recording is determined and decides a recording mode with reference to the correspondence information. Alternatively, the recording mode may be decided using an AI technique (artificial intelligence technique).

In Step S401, the decided recording mode is discriminated. In Step S402 or Step S403, in accordance with the decided recording mode, the number of passes is set. In Step S404, the recording is carried out. As the type of recording mode, although two recording modes, that is, a first recording mode and a second recording mode, are shown in the drawing, the number of recording modes may also be at least three.

In this example, the recording apparatus is able to change the number of passes (the number of the main scannings performed in the same recording region of the recording medium) in accordance with the recording mode, and various types of recordings can be preferably performed.

According to the ink jet recording apparatus described above by way of example, the recording method of this embodiment can be preferably performed.

### 4. Examples

Hereinafter, although the present disclosure will be described in more detail with reference to Examples, the present disclosure is not limited thereto. Hereinafter, “%” is represented on mass basis unless otherwise particularly noted.

### 4.1. Preparation of Pigment Dispersion Liquid A

In a reaction chamber equipped with a dripping funnel, a nitrogen induction tube, a reflux condenser, a thermometer, and a stirrer, 50 g of methyl ethyl ketone (MEK) was charged and then heated to 75° C. with nitrogen bubbling. In this chamber, a mixture of monomers, that is, 80 g of butyl methacrylate, 50 g of methyl methacrylic acid, 15 g of styrene, and 20 g of methacrylic acid; 50 g of MEK; and 500 mg of a polymerization initiator (azobisisobutyronitrile: AIBN) was dripped by the dripping funnel over 3 hours. After the dripping was finished, heat reflux was performed for 6 hours, and after spontaneous cooling, MEK was then added to compensate for the loss thereof caused by evaporation, so that a resin solution (resin solid content: 50 percent by mass, acid value: 79 mgKOH/KOH, Tg: 65° C.) was obtained. Subsequently, after 20 g of this solution was neutralized with a predetermined amount of ammonia water at a concentration of 20 percent by mass functioning as a neutralizer so as to neutralize 100% of salt-forming groups, 50 g of a pigment (C.I. Pigment Blue 15: 3) was gradually added thereto with stirring, and then kneading was performed using a bead mill for 2 hours. After 200 g of ion exchange water was added to a kneaded product thus obtained and stirred, MEK was removed by heating in a reduced-pressure environment. Furthermore, the concentration was adjusted with ion exchange water, so that a pigment dispersion (pigment solid content: 20 percent by mass, resin solid content: 5 percent by weight) was obtained.

### 4.2. Preparation of Water-Dispersible Resin

In a reaction chamber equipped with a stirrer, a reflux condenser, a dripping device, and a thermometer, 2,600 g of ion exchange water and 0.5 g of sodium lauryl sulfate were charged and then heated to 70° C. with stirring while nitrogen purge was performed. The inside temperature was maintained at 70° C., and after 4 g of potassium persulfate was added as a polymerization initiator and dissolved, an emulsion formed in advance by adding 2 g of acrylamide, 180 g of methyl methacrylate, 25 g of butyl acrylate, and 2 g of methacrylic acid to 300 g of ion exchange water and 0.5 g of sodium lauryl sulfate with stirring was continuously dripped in a reaction solution over 3 hours. After the dripping was finished, ageing was performed for 1 hour. After the ageing was finished, an emulsion formed in advance by adding 30 g of acrylamide, 1,200 g of styrene, 200 g of 2-ethylhexyl methacrylate, and 30 g of methacrylic acid to 500 g of ion exchange water and 1.5 g of sodium lauryl sulfate with stirring was continuously dripped in the reaction solution over 4 hours. After the dripping was finished, ageing was performed for 3 hours. After an aqueous emulsion thus obtained was cooled to ordinary temperature, ion exchange water and a sodium hydroxide water solution were added for adjustment so as to have a solid content of 30 percent by weight and a pH of 8. As described above, a water-dispersible resin (resin A) having no cross-linking structure was formed. Furthermore, by adjusting the monomer ratio, a water-dispersible resin (resin B) and a water-dispersible resin (resin C) were formed in a manner similar to that described above. In addition, when the resin B and the resin C were prepared, the preparation was performed without changing the total amount such that the amount of methacrylic acid was increased, and the other monomers were decreased in an amount corresponding thereto while the respective ratios thereof were not changed.

### 4.3. Preparation of Ink Composition

After individual components were charged in a container to have one of compositions shown in Tables 1 and 2 and then mixed and stirred for 2 hours by a magnetic stirrer, filtration was performed by a membrane filter having a pore diameter of 5 m, so that ink compositions (inks 1 to 23) according to Examples and Comparative Examples were obtained.

TABLE 1

| | | | INK 1 | INK 2 | INK 3 | INK 4 |
|---|---|---|---|---|---|---|
| PIGMENT | PIGMENT | PIGMENT | 4.0 | — | 4.0 | 4.0 |
| DISPERSION | DISPERSANT TYPE | (c) PIGMENT DISPERSANT | 1.0 | — | 1.0 | 1.0 |
| LIQUID | (PIGMENT DISPERSION | | | | | |
| | LIQUID A) | | | | | |
| | SELF-DISPERSIBLE | PIGMENT DISPERSION | — | 4.0 | — | — |
| | PIGMENT | LIQUID B | | | | |
| WATER- | RESIN A (ACID VALUE: 15) | | 6.0 | 6.0 | 6.0 | 6.0 |
| DISPERSIBLE | RESIN B (ACID VALUE: 30) | | — | — | — | — |
| RESIN (a) | RESIN C (ACID VALUE: 45) | | — | — | — | — |
| | HITECH E-6500 | | 0.5 | 0.5 | 0.5 | 0.5 |
| WATER- | MALEIC ACID-BASED | XIRAN 2625H | 0.4 | 0.4 | — | — |
| SOLUBLE | RESIN | XIRAN 3000H | — | — | 0.4 | — |
| RESIN (b) | | XIRAN 3000HNa | — | — | — | 0.4 |
| | | SN DISPERSANT 5027 | — | — | — | — |
| | | POLYMALONE 1318 | — | — | — | — |
| | STYRENE-ACRYLIC | JOHNCRYL HPD196 | — | — | — | — |
| | RESIN | | | | | |
| WATER- | DIOL | PG | 15.0 | 15.0 | 15.0 | 15.0 |
| SOLUBLE | | 1,2HD | 1.0 | 1.0 | 1.0 | 1.0 |
| LOW | RESIN SOLUBLE | CPL | 8.0 | 8.0 | 8.0 | 8.0 |
| MOLECULAR | COMPOUND | 2P | — | — | — | — |
| WEIGHT | | DMPA | — | — | — | — |
| ORGANIC | | DMSO | — | — | — | — |
| COMPOUND | | EOXM | — | — | — | — |
| | ANOTHER COMPOUND | TIPA | 1.0 | 1.0 | 1.0 | 1.0 |
| DEFOAMING AGENT | | SURFYNOL DF110D | 0.2 | 0.2 | 0.2 | 0.2 |
| SURFACTANT | | BYK333 | 0.5 | 0.5 | 0.5 | 0.5 |
| PURE WATER | | | BALANCE | BALANCE | BALANCE | BALANCE |
| TOTAL | | | 100 | 100 | 100 | 100 |
| WATER-SOLUBLE RESIN (b)/WATER-DISPERSIBLE RESIN (a) | | | 0.06 | 0.06 | 0.06 | 0.06 |
| PIGMENT DISPERSANT (c) + WATER-SOLUBLE RESIN (b) | | | 1.4 | 0.4 | 1.4 | 1.4 |
| ADDITION AMOUNT OF WATER-SOLUBLE LOW MOLECULAR | | | 25.0 | 25.0 | 25.0 | 25.0 |
| WEIGHT ORGANIC COMPOUND | | | | | | |
| STORAGE STABILITY | | | A | A | A | A |
| | | | INK 5 | INK 6 | INK 7 | INK 8 |
| PIGMENT | PIGMENT | PIGMENT | 4.0 | 4.0 | 4.0 | 4.0 |
| DISPERSION | DISPERSANT TYPE | (c) PIGMENT DISPERSANT | 1.0 | 1.0 | 1.0 | 1.0 |
| LIQUID | (PIGMENT DISPERSION | | | | | |
| | LIQUID A) | | | | | |
| | SELF-DISPERSIBLE | PIGMENT DISPERSION | — | — | — | — |
| | PIGMENT | LIQUID B | | | | |
| WATER- | RESIN A (ACID VALUE: 15) | | 6.0 | 6.0 | 6.0 | 6.0 |
| DISPERSIBLE | RESIN B (ACID VALUE: 30) | | — | — | — | — |
| RESIN (a) | RESIN C (ACID VALUE: 45) | | — | — | — | — |
| | HITECH E-6500 | | 0.5 | 0.5 | 0.5 | 0.5 |
| WATER- | MALEIC ACID-BASED | XIRAN 2625H | — | — | 0.8 | 0.2 |
| SOLUBLE | RESIN | XIRAN 3000H | — | — | — | — |
| RESIN (b) | | XIRAN 3000HNa | — | — | — | — |
| | | SN DISPERSANT 5027 | 0.4 | — | — | — |
| | | POLYMALONE 1318 | — | 0.4 | — | — |
| | STYRENE-ACRYLIC | JOHNCRYL HPD196 | — | — | — | — |
| | RESIN | | | | | |
| WATER- | DIOL | PG | 15.0 | 15.0 | 15.0 | 15.0 |
| SOLUBLE | | 1,2HD | 1.0 | 1.0 | 1.0 | 1.0 |
| LOW | RESIN SOLUBLE | CPL | 8.0 | 8.0 | 8.0 | 8.0 |
| MOLECULAR | COMPOUND | 2P | — | — | — | — |
| WEIGHT | | DMPA | — | — | — | — |
| ORGANIC | | DMSO | — | — | — | — |
| COMPOUND | | EOXM | — | — | — | — |
| | ANOTHER COMPOUND | TIPA | 1.0 | 1.0 | 1.0 | 1.0 |
| DEFOAMING AGENT | | SURFYNOL DF110D | 0.2 | 0.2 | 0.2 | 0.2 |
| SURFACTANT | | BYK333 | 0.5 | 0.5 | 0.5 | 0.5 |
| PURE WATER | | | BALANCE | BALANCE | BALANCE | BALANCE |
| TOTAL | | | 100 | 100 | 100 | 100 |
| WATER-SOLUBLE RESIN (b)/WATER-DISPERSIBLE RESIN (a) | | | 0.06 | 0.06 | 0.12 | 0.03 |
| PIGMENT DISPERSANT (c) + WATER-SOLUBLE RESIN (b) | | | 1.4 | 1.4 | 1.8 | 1.2 |
| ADDITION AMOUNT OF WATER-SOLUBLE LOW MOLECULAR | | | 25.0 | 25.0 | 25.0 | 25.0 |
| WEIGHT ORGANIC COMPOUND | | | | | | |
| STORAGE STABILITY | | | A | A | A | A |
| | | | INK 9 | INK 10 | INK 11 | INK 12 |
| PIGMENT | PIGMENT | PIGMENT | 4.0 | 4.0 | 4.0 | 4.0 |
| DISPERSION | DISPERSANT TYPE | (c) PIGMENT DISPERSANT | 1.0 | 1.0 | 1.0 | 1.0 |
| LIQUID | (PIGMENT DISPERSION | | | | | |
| | LIQUID A) | | | | | |
| | SELF-DISPERSIBLE | PIGMENT DISPERSION | — | — | — | — |
| | PIGMENT | LIQUID B | | | | |
| WATER- | RESIN A (ACID VALUE: 15) | | 3.0 | 9.0 | — | 6.0 |
| DISPERSIBLE | RESIN B (ACID VALUE: 30) | | — | — | 6.0 | — |
| RESIN (a) | RESIN C (ACID VALUE: 45) | | — | — | — | — |
| | HITECH E-6500 | | 0.5 | 0.5 | 0.5 | 0.5 |
| WATER- | MALEIC ACID-BASED | XIRAN 2625H | 0.4 | 0.4 | 0.4 | 0.4 |
| SOLUBLE | RESIN | XIRAN 3000H | — | — | — | — |
| RESIN (b) | | XIRAN 3000HNa | — | — | — | — |
| | | SN DISPERSANT 5027 | — | — | — | — |
| | | POLYMALONE 1318 | — | — | — | — |
| | STYRENE-ACRYLIC | JOHNCRYL HPD196 | — | — | — | — |
| | RESIN | | | | | |
| WATER- | DIOL | PG | 15.0 | 15.0 | 15.0 | 15.0 |
| SOLUBLE | | 1,2HD | 1.0 | 1.0 | 1.0 | 1.0 |
| LOW | RESIN SOLUBLE | CPL | 8.0 | 8.0 | 8.0 | — |
| MOLECULAR | COMPOUND | 2P | — | — | — | 8.0 |
| WEIGHT | | DMPA | — | — | — | — |
| ORGANIC | | DMSO | — | — | — | — |
| COMPOUND | | EOXM | — | — | — | — |
| | ANOTHER COMPOUND | TIPA | 1.0 | 1.0 | 1.0 | 1.0 |

| | | | | | |
|---|---|---|---|---|---|
| DEFOAMING AGENT | SURFYNOL DF110D | 0.2 | 0.2 | 0.2 | 0.2 |
| SURFACTANT | BYK333 | 0.5 | 0.5 | 0.5 | 0.5 |

| | | | | |
|---|---|---|---|---|
| PURE WATER | BALANCE | BALANCE | BALANCE | BALANCE |
| TOTAL | 100 | 100 | 100 | 100 |
| WATER-SOLUBLE RESIN (b)/WATER-DISPERSIBLE RESIN (a) | 0.11 | 0.04 | 0.06 | 0.06 |
| PIGMENT DISPERSANT (c) + WATER-SOLUBLE RESIN (b) | 1.4 | 1.4 | 1.4 | 1.4 |
| ADDITION AMOUNT OF WATER-SOLUBLE LOW MOLECULAR | 25.0 | 25.0 | 25.0 | 25.0 |
| WEIGHT ORGANIC COMPOUND | | | | |
| STORAGE STABILITY | A | A | A | A |

TABLE 2

| | | | INK 13 | INK 14 | INK 15 | INK 16 |
|---|---|---|---|---|---|---|
| PIGMENT | PIGMENT | PIGMENT | 4.0 | 4.0 | 4.0 | 4.0 |
| DISPERSION | DISPERSANT TYPE | (c) PIGMENT DISPERSANT | 1.0 | 1.0 | 1.0 | 1.0 |
| LIQUID | (PIGMENT DISPERSION | | | | | |
| | LIQUID A) | | | | | |
| | SELF-DISPERSIBLE | PIGMENT DISPERSION | — | — | — | — |
| | PIGMENT | LIQUID B | | | | |
| WATER- | RESIN A (ACID VALUE: 15) | | | 6.0 | 6.0 | 6.0 |
| DISPERSIBLE | RESIN B (ACID VALUE: 30) | | | — | — | — |
| RESIN (a) | RESIN C (ACID VALUE: 45) | | | — | — | — |
| | HITECH E-6500 | | | 0.5 | 0.5 | 0.5 |
| WATER- | MALEIC ACID-BASED | XIRAN 2625H | 0.4 | 0.4 | 0.4 | 0.4 |
| SOLUBLE | RESIN | XIRAN 3000H | — | — | — | — |
| RESIN (b) | | XIRAN 3000HNa | — | — | — | — |
| | | SN DISPERSANT 5027 | — | — | — | — |
| | | POLYMALONE 1318 | — | — | — | — |
| | STYRENE-ACRYLIC | JOHNCRYL HPD196 | — | — | — | — |
| | RESIN | | | | | |
| WATER- | DIOL | PG | 15.0 | 15.0 | 15.0 | 15.0 |
| SOLUBLE | | 1,2HD | 1.0 | 1.0 | 1.0 | 1.0 |
| LOW | RESIN SOLUBLE | CPL | — | — | — | 12.0 |
| MOLECULAR | COMPOUND | 2P | — | — | — | — |
| WEIGHT | | DMPA | 8.0 | — | — | — |
| ORGANIC | | DMSO | — | 8.0 | — | — |
| COMPOUND | | EOXM | — | — | 8.0 | — |
| | ANOTHER COMPOUND | TIPA | 1.0 | 1.0 | 1.0 | 1.0 |
| DEFOAMING AGENT | | SURFYNOL DF110D | 0.2 | 0.2 | 0.2 | 0.2 |
| SURFACTANT | | BYK333 | 0.5 | 0.5 | 0.5 | 0.5 |
| PURE WATER | | | BALANCE | BALANCE | BALANCE | BALANCE |
| TOTAL | | | 100 | 100 | 100 | 100 |
| WATER-SOLUBLE RESIN (b)/WATER-DISPERSIBLE RESIN (a) | | | 0.06 | 0.06 | 0.06 | 0.06 |
| PIGMENT DISPERSANT (c) + WATER-SOLUBLE RESIN (b) | | | 1.4 | 1.4 | 1.4 | 1.4 |
| ADDITION AMOUNT OF WATER-SOLUBLE LOW MOLECULAR WEIGHT | | | 25.0 | 25.0 | 25.0 | 25.0 |
| ORGANIC COMPOUND | | | | | | |
| STORAGE STABILITY | | | A | B | B | B |
| | | | INK 17 | INK 18 | INK 19 | INK 20 |
| PIGMENT | PIGMENT | PIGMENT | 4.0 | 4.0 | 4.0 | 4.0 |
| DISPERSION | DISPERSANT TYPE | (c) PIGMENT DISPERSANT | 1.0 | 1.0 | 1.0 | 1.0 |
| LIQUID | (PIGMENT DISPERSION | | | | | |
| | LIQUID A) | | | | | |
| | SELF-DISPERSIBLE | PIGMENT DISPERSION | — | — | — | — |
| | PIGMENT | LIQUID B | | | | |
| WATER- | RESIN A (ACID VALUE: 15) | | 6.0 | 6.0 | 6.0 | 6.0 |
| DISPERSIBLE | RESIN B (ACID VALUE: 30) | | — | — | — | — |
| RESIN (a) | RESIN C (ACID VALUE: 45) | | — | — | — | — |
| | HITECH E-6500 | | 0.5 | 0.5 | 0.5 | 0.5 |
| WATER- | MALEIC ACID-BASED | XIRAN 2625H | 0.4 | — | — | 1.2 |
| SOLUBLE | RESIN | XIRAN 3000H | — | — | — | — |
| RESIN (b) | | XIRAN 3000HNa | — | — | — | — |
| | | SN DISPERSANT 5027 | — | — | — | — |
| | | POLYMALONE 1318 | — | — | — | — |
| | STYRENE-ACRYLIC | JOHNCRYL HPD196 | — | 0.4 | — | — |
| | RESIN | | | | | |
| WATER- | DIOL | PG | 15.0 | 15.0 | 15.0 | 15.0 |
| SOLUBLE | | 1,2HD | 1.0 | 1.0 | 1.0 | 1.0 |
| LOW | RESIN SOLUBLE | CPL | 4.0 | 8.0 | 8.0 | 8.0 |
| MOLECULAR | COMPOUND | 2P | — | — | — | — |
| WEIGHT | | DMPA | — | — | — | — |
| ORGANIC | | DMSO | — | — | — | — |
| COMPOUND | | EOXM | — | — | — | — |
| | ANOTHER COMPOUND | TIPA | 1.0 | 1.0 | 1.0 | 1.0 |

| | | | | | |
|---|---|---|---|---|---|
| DEFOAMING AGENT | SURFYNOL DF110D | 0.2 | 0.2 | 0.2 | 0.2 |
| SURFACTANT | BYK333 | 0.5 | 0.5 | 0.5 | 0.5 |

| | | | | |
|---|---|---|---|---|
| PURE WATER | BALANCE | BALANCE | BALANCE | BALANCE |
| TOTAL | 100 | 100 | 100 | 100 |
| WATER-SOLUBLE RESIN (b)/WATER-DISPERSIBLE RESIN (a) | 0.06 | 0.06 | 0.00 | 0.18 |
| PIGMENT DISPERSANT (c) + WATER-SOLUBLE RESIN (b) | 1.4 | 1.4 | 1.0 | 2.2 |
| ADDITION AMOUNT OF WATER-SOLUBLE LOW MOLECULAR WEIGHT | 25.0 | 25.0 | 25.0 | 25.0 |
| ORGANIC COMPOUND | | | | |
| STORAGE STABILITY | A | A | A | A |

| | | | INK 21 | INK 22 | INK 23 |
|---|---|---|---|---|---|
| PIGMENT | PIGMENT | PIGMENT | 4.0 | 4.0 | 4.0 |
| DISPERSION | DISPERSANT TYPE | (c) PIGMENT DISPERSANT | 1.0 | 1.0 | 1.0 |
| LIQUID | (PIGMENT DISPERSION | | | | |
| | LIQUID A) | | | | |
| | SELF-DISPERSIBLE | PIGMENT DISPERSION | — | — | — |
| | PIGMENT | LIQUID B | | | |
| WATER- | RESIN A (ACID VALUE: 15) | | 6.0 | — | — |
| DISPERSIBLE | RESIN B (ACID VALUE: 30) | | — | — | — |
| RESIN (a) | RESIN C (ACID VALUE: 45) | | — | 6.0 | — |
| | HITECH E-6500 | | 0.5 | 0.5 | — |
| WATER- | MALEIC ACID-BASED | XIRAN 2625H | 1.6 | 0.4 | 0.4 |
| SOLUBLE | RESIN | XIRAN 3000H | — | — | — |
| RESIN (b) | | XIRAN 3000HNa | — | — | — |
| | | SN DISPERSANT 5027 | — | — | — |
| | | POLYMALONE 1318 | — | — | — |
| | STYRENE-ACRYLIC | JOHNCRYL HPD196 | — | — | — |
| | RESIN | | | | |
| WATER- | DIOL | PG | 15.0 | 15.0 | 15.0 |
| SOLUBLE | | 1,2HD | 1.0 | 1.0 | 1.0 |
| LOW | RESIN SOLUBLE | CPL | 8.0 | 8.0 | 8.0 |
| MOLECULAR | COMPOUND | 2P | — | — | — |
| WEIGHT | | DMPA | — | — | — |
| ORGANIC | | DMSO | — | — | — |
| COMPOUND | | EOXM | — | — | — |
| | ANOTHER COMPOUND | TIPA | 1.0 | 1.0 | 1.0 |

| | | | | |
|---|---|---|---|---|
| DEFOAMING AGENT | SURFYNOL DF110D | 0.2 | 0.2 | 0.2 |
| SURFACTANT | BYK333 | 0.5 | 0.5 | 0.5 |

| | | | |
|---|---|---|---|
| PURE WATER | BALANCE | BALANCE | BALANCE |
| TOTAL | 100 | 100 | 100 |
| WATER-SOLUBLE RESIN (b)/WATER-DISPERSIBLE RESIN (a) | 0.25 | 0.06 | — |
| PIGMENT DISPERSANT (c) + WATER-SOLUBLE RESIN (b) | 2.6 | 1.4 | 1.4 |
| ADDITION AMOUNT OF WATER-SOLUBLE LOW MOLECULAR WEIGHT | 25.0 | 25.0 | 25.0 |
| ORGANIC COMPOUND | | | |
| STORAGE STABILITY | A | A | AA |

Abbreviations and the like in Tables 1 and 2 are shown below.
Pigment: C.I. Pigment Blue 15: 3
Pigment dispersant: See above “2.1. Preparation of Pigment Dispersion Liquid A”.
Pigment dispersion liquid: Pigment dispersion liquid B “CAB-O-JET 450C” self-dispersible pigment dispersion liquid, manufactured by Cabot Corporation.
Resin A (acid value: 15): See above “2.2. Preparation of Water-Dispersible Resin”, Tg: 90° C., aggregation property: “C”.
Resin B (acid value: 30): See above “2.2. Preparation of Water-Dispersible Resin”, Tg: 90° C., aggregation property: “C”.
Resin C (acid value: 45): See above “2.2. Preparation of Water-Dispersible Resin”, Tg: 90° C., aggregation property: “B”.
Hitech E-6500: Wax emulsion, nonionic polyethylene wax, manufactured by Toho Chemical Industry Co., Ltd., aggregation property: “C”.

In the abbreviations shown below, the weight average molecular weight, the neutralizing salt, the structure, the producer, and the aggregation property are described in this order.
XIRAN 2625H: 9,000; ammonia; styrene-maleic anhydride half ester resin; manufactured by Polyscope; A
XIRAN 3000H: 10,000; ammonia; styrene-maleic anhydride half ester resin; manufactured by Polyscope; B
XIRAN 3000HNa: 10,000; sodium hydroxide; styrene-maleic anhydride half ester resin; manufactured by Polyscope; A
SN Dispersant 5027: 18,000; ammonia; styrene-maleic anhydride half ester resin; manufactured by San Nopco; A
Polymalone 1318: 50,000; ammonia; styrene-maleic anhydride half ester resin; manufactured by Arakawa Chemical Industries, Ltd.; A
Johncryl HPD196: 9,200; ammonia; styrene-acrylic resin; manufactured by BASF; C

The weight average molecular weight was measured using a high speed GPC apparatus (“HLC-8220GPC” manufactured by Tosoh Corporation). As the standard material, a polystyrene sample was used, and tetrahydrofuran (THF) was used as a mobile phase.

The aggregation property was evaluated by visual inspection of the state obtained such that after a water solution containing calcium propionate at a concentration of 5 percent by mass was mixed and stirred with a water solution (water dispersion liquid) containing a resin at a solid content of 1 percent by mass to have a mass ratio of the resin solid content to calcium propionate of 2:1 and then still left for 5 minutes. The evaluation criteria are as shown below.

A: Precipitate is generated (high reactivity).

B: colloidal state is formed (reactivity).

C: uniform state with no aggregates (no reactivity, no change before and after mixing).
Surfynol DF110D: defoaming agent, acetylene diol-based surfactant, manufactured by Nisshin Chemical Industry Co., Ltd.
BYK 333: Surfactant, silicone-based surfactant, manufactured by BYK Japan KK.

In the abbreviations shown below, the name, the standard boiling point, the melting point, the state, and the classification are described in this order.
PG: propylene glycol; 188° C., −59° C., liquid; diol
1,2HD: 1,2-hexanediol; 224° C., 2° C., liquid; diol
CPL: ε-caprolactam; 267° C., 70° C., solid; nitrogen-containing solvent (cyclic amide)
2P: 2-pyrrolidone; 245° C., 25° C., liquid; nitrogen-containing solvent (cyclic amide)
DMPA: 3-methoxy-N,N-dimethylpropanamide; 215° C., −49° C., liquid; nitrogen-containing solvent (chain amide)
DMSO: dimethylsulfoxide; 189° C., 19° C., liquid; sulfur-containing solvent
EXOM: 3-ethyl-3-oxetanemethanol; 220° C., −31° C., liquid; cyclic ether
TIPA: triisopropanolamine; 301° C., 45° C., solid; amine

### 4.4. Preparation of Treatment Liquid

After individual components were charged in a container to have one of the compositions shown in Table 3 and then mixed and stirred for 2 hours by a magnetic stirrer, filtration was performed using a membrane filter having a pore size of 5 m, so that treatment liquids (treatment liquids 1 to 5) according to Examples and Comparative Examples were obtained. In the table, the pigment dispersion liquid represents a solid content of the pigment, and the resin represents a solid content of the resin.

TABLE 3

| | | TREATMENT | TREATMENT | TREATMENT | TREATMENT | TREATMENT |
|---|---|---|---|---|---|---|
| | | LIQUID 1 | LIQUID 2 | LIQUID 3 | LIQUID 4 | LIQUID 5 |
| POLYVALENT METAL | CALCIUM PROPIONATE | 8.0 | — | — | — | 8.0 |
| SALT | MAGNESIUM SULFATE 7 | — | 8.0 | — | — | — |
| | HYDRATES | | | | | |
| CATIONIC RESIN | CATIOMASTER PD-30 | — | — | 3.0 | — | — |
| ORGANIC ACID | L-TARTARIC ACID | 0.1 | 0.1 | 0.1 | 4.0 | 0.1 |
| WATER-SOLUBLE | PG | 15.0 | 15.0 | 15.0 | 15.0 | 15.0 |
| LOW MOLECULAR | 1,2HD | 1.0 | 1.0 | 1.0 | 1.0 | 1.0 |
| WEIGHT ORGANIC | | | | | | |
| COMPOUND (DIOL) | | | | | | |
| WATER-SOLUBLE | CPL | 8.0 | 8.0 | 8.0 | 8.0 | — |
| LOW MOLECULAR | 2P | — | — | — | — | 8.0 |
| WEIGHT ORGANIC | | | | | | |
| COMPOUND (RESIN | | | | | | |
| SOLUBLE COMPOUND) | | | | | | |
| DEFOAMING AGENT | SURFYNOL DF110D | 0.2 | 0.2 | 0.2 | 0.2 | 0.2 |
| SURFACTANT | BYK333 | 0.5 | 0.5 | 0.5 | 0.5 | 0.5 |

| | | | | | |
|---|---|---|---|---|---|
| PURE WATER | BALANCE | BALANCE | BALANCE | BALANCE | BALANCE |
| TOTAL | 100 | 100 | 100 | 100 | 100 |

Abbreviations and the like in Table 3 are as shown below.
Cationmaster PD-30: aggregating agent, cationic resin (amine-epichlorohydrin copolymer), manufactured by Yokkaichi Chemical Company Limited.

In the abbreviations shown below, the name, the standard boiling point, the melting point, the state, and the classification are described in this order.
PG: propylene glycol; 188° C.; −59° C.; liquid; diol
1,2HD: 1,2-hexandiol; 224° C.; 2° C.; liquid; diol
CPL: ε-caprolactam; 267° C.; 70° C.; solid; nitrogen-containing solvent (cyclic amide)
2P: 2-pyrrolidone; 245° C.; 25° C.; liquid; nitrogen-containing solvent (cyclic amide)
Surfynol DF110D: defoaming agent, acetylenediol-based surfactant, manufactured by Nisshin Chemical Industry Co., Ltd.
BYK 333: surfactant, silicone-based surfactant, manufactured by BYK Japan KK.

### 4.5. Evaluation Method

### 4.5.1. Storage Stability of Ink Composition

After 30 g of each ink composition thus prepared was sealed in an aluminum pack so as not to incorporate air bubbles, this aluminum pack was left in a temperature-constant bath at 60° C. for 6 days. After the aluminum pack was recovered from the bath and spontaneously cooled, a viscosity of the ink composition was measured at a shear rate of 200 sec⁻¹ using a rheometer (MCR702, manufactured by Anton Paar) and was compared with a viscosity thereof at an initial stage (immediately after the ink preparation) to obtain a viscosity increase rate. From this viscosity increase rate, the storage stability was evaluated in accordance with the following criteria, and the results are shown in Tables 1 and 2.

AA: viscosity increase rate of less than 1%

A: viscosity increase rate of 1% to less than 3%

B: viscosity increase rate of 3% to less than 5%

C: viscosity increase rate of 5% or more

### 4.5.2. Test Conditions

As a recording apparatus, a modified SC-R5050 machine (manufactured by Seiko Epson Corporation) was used, and a solid pattern (formed only from cyan) was recorded at a resolution of 1,200×1,200 dpi, an ink composition adhesion amount of 16 mg/inch², and a treatment liquid adhesion amount shown in Table 4. As a recording medium, Orejet 3165G-010 (vinyl chloride film, manufactured by Orafol Japan) was used, and the number of scannings performed for recording was 9. A surface temperature of the recording medium on a platen was set as shown in Table 4 by adjusting a platen heater (primary heating), and a secondary heating temperature was set to 90° C., so that a recorded matter of each Example was obtained.

### 4.5.3. Image Quality (Aggregation Irregularity)

Under the test conditions described above, a solid pattern was printed under print conditions shown in Table 4, and a printed matter thus obtained was observed by visual inspection. Evaluation was performed in accordance with the following criteria, and the results are shown in Table 4.

AA: No aggregation irregularity is observed.

A: Although being observed, aggregation irregularity is not apparent.

B: Although being apparent, aggregation irregularity is acceptable.

C: Aggregation irregularity is apparent.

### 4.5.4. Abrasion Resistance

Under the test conditions described above, after a solid pattern was printed on a recording medium under print conditions shown in Table 4 and was then left at room temperature for 30 minutes, a solid pattern printed portion was cut into a rectangle having a size of 30 mm×150 mm, and rubbing was performed 100 times using a plain woven cloth by a Gakushin type abrasion tester (load: 500 g). Subsequently, the degree of peeling of the ink was confirmed by visual inspection and evaluated in accordance with the following criteria, and the results are shown in Table 4.

AA: No peeling is confirmed.

A: less than 20% of evaluation region is peeled off.

B: 20% to less than 40% of evaluation region is peeled off.

C: 40% to less than 50% of evaluation region is peeled off.

D: 50% or more of evaluation region is peeled off.

### 4.5.5. Clogging Recovery Property (Ink Composition

A recording apparatus to satisfy the test conditions described above was prepared. However, non-ejection was intentionally generated in a nozzle of an ink head. In the state described above, idle running was performed for 3 hours with no ink ejection from the head under the print conditions shown in Table 4. After the idle running was finished, cleaning was performed 3 times, and the number of missing nozzles was finally confirmed. In one cleaning, 1 g of the ink was ejected from a nozzle line. In addition, the non ejection from the nozzle was generated by tapping a nozzle surface with a BEMCOT wiper wetted with water. The nozzle line was formed of 400 nozzles. Evaluation was performed in accordance with the following criteria, and the results are shown in Table 4.

AA: No-ejection nozzles are not confirmed.

A: No-ejection nozzles are less than 3%.

B: No-ejection nozzles are 3% to less than 5%.

C: No-ejection nozzles are 5% or more.

### 4.5.6. Landing Deviation (Treatment Liquid) and Landing Deviation (Ink Composition)

A recording apparatus to satisfy the test conditions described above was prepared. Immediately after being flushed, the ink and the treatment liquid were each recorded to form a nozzle check pattern. Idle running was performed under the print conditions shown in Table 4 without ejecting the treatment liquid and the ink for 1 minute, and after the idle running was finished, a nozzle check pattern similar to that described above was recorded. The average values were obtained from all the nozzles for the ink and the treatment liquid. However, the no-ejection nozzles were excluded. Evaluation was performed in accordance with the following criteria, and the results are shown in Table 4.

AA: No difference in landing position is observed before and after idle running.

A: Half of inter nozzle distance or less is deviated.

B: Inter nozzle distance or less is deviated.

C: More than inter nozzle distance is deviated.

TABLE 4

| | EXAMPLE | EXAMPLE | EXAMPLE | EXAMPLE |
|---|---|---|---|---|
| | 1 | 2 | 3 | 4 |
| INK | 1 | 2 | 3 | 4 |
| TREATMENT LIQUID | 1 | 1 | 1 | 1 |
| ADHESION AMOUNT OF TREATMENT LIQUID (%) (TO INK) | 10.0 | 10.0 | 10.0 | 10.0 |
| PRIMARY HEATING TEMPERATURE (° C.) | 35 | 35 | 35 | 35 |
| IMAGE QUALITY (AGGREGATION IRREGULARITY) | A | A | B | B |
| ABRASION RESISTANCE | A | A | B | B |
| CLOGGING RECOVERY PROPERTY (INK) | A | B | A | B |
| LANDING DEVIATION (TREATMENT LIQUID) | A | A | A | A |
| LANDING DEVIATION (INK) | A | A | A | A |
| | A | A | A | A |

| | EXAMPLE | EXAMPLE | EXAMPLE |
|---|---|---|---|
| | 5 | 6 | 7 |
| INK | 5 | 6 | 7 |
| TREATMENT LIQUID | 1 | 1 | 1 |
| ADHESION AMOUNT OF TREATMENT LIQUID (%) (TO INK) | 10.0 | 10.0 | 10.0 |
| PRIMARY HEATING TEMPERATURE (° C.) | 35 | 35 | 35 |
| IMAGE QUALITY (AGGREGATION IRREGULARITY) | A | A | AA |
| ABRASION RESISTANCE | A | A | AA |
| CLOGGING RECOVERY PROPERTY (INK) | A | A | B |
| LANDING DEVIATION (TREATMENT LIQUID) | A | B | A |
| LANDING DEVIATION (INK) | A | A | A |
| | B | B | B |

| | EXAMPLE | EXAMPLE | EXAMPLE |
|---|---|---|---|
| | 8 | 9 | 10 |
| INK | 8 | 9 | 10 |
| TREATMENT LIQUID | 1 | 1 | 1 |
| ADHESION AMOUNT OF TREATMENT LIQUID (%) (TO INK) | 10.0 | 10.0 | 10.0 |
| PRIMARY HEATING TEMPERATURE (° C.) | 35 | 35 | 35 |
| IMAGE QUALITY (AGGREGATION IRREGULARITY) | B | B | A |
| ABRASION RESISTANCE | B | B | A |
| CLOGGING RECOVERY PROPERTY (INK) | A | B | AA |
| LANDING DEVIATION (TREATMENT LIQUID) | A | AA | B |
| LANDING DEVIATION (INK) | A | A | A |
| | A | AA | B |

| | EXAMPLE | EXAMPLE | EXAMPLE | EXAMPLE |
|---|---|---|---|---|
| | 11 | 12 | 13 | 14 |
| INK | 11 | 1 | 1 | 1 |
| TREATMENT LIQUID | 1 | 2 | 3 | 4 |
| ADHESION AMOUNT OF TREATMENT LIQUID (%)(TO INK) | 10.0 | 10.0 | 10.0 | 10.0 |
| PRIMARY HEATING TEMPERATURE (° C.) | 35 | 35 | 35 | 35 |
| IMAGE QUALITY (AGGREGATION IRREGULARITY) | A | B | B | B |
| ABRASION RESISTANCE | B | B | A | B |
| CLOGGING RECOVERY PROPERTY (INK) | A | A | A | A |
| LANDING DEVIATION (TREATMENT LIQUID) | A | A | B | A |
| LANDING DEVIATION (INK) | A | A | A | A |

| | EXAMPLE | EXAMPLE | EXAMPLE |
|---|---|---|---|
| | 15 | 16 | 17 |
| INK | 1 | 12 | 13 |
| TREATMENT LIQUID | 1 | 1 | 1 |
| ADHESION AMOUNT OF TREATMENT LIQUID (%)(TO INK) | 20.0 | 10.0 | 10.0 |
| PRIMARY HEATING TEMPERATURE (° C.) | 35 | 35 | 35 |
| IMAGE QUALITY (AGGREGATION IRREGULARITY) | AA | A | A |
| ABRASION RESISTANCE | B | A | A |
| CLOGGING RECOVERY PROPERTY (INK) | A | A | B |
| LANDING DEVIATION (TREATMENT LIQUID) | A | A | A |
| LANDING DEVIATION (INK) | A | A | A |

| | EXAMPLE | EXAMPLE | EXAMPLE |
|---|---|---|---|
| | 18 | 19 | 20 |
| INK | 14 | 15 | 16 |
| TREATMENT LIQUID | 1 | 1 | 1 |
| ADHESION AMOUNT OF TREATMENT LIQUID (%)(TO INK) | 10.0 | 10.0 | 10.0 |
| PRIMARY HEATING TEMPERATURE (° C.) | 35 | 35 | 35 |
| IMAGE QUALITY (AGGREGATION IRREGULARITY) | A | A | AA |
| ABRASION RESISTANCE | B | B | AA |
| CLOGGING RECOVERY PROPERTY (INK) | B | B | B |
| LANDING DEVIATION (TREATMENT LIQUID) | A | A | A |
| LANDING DEVIATION (INK) | A | A | B |

| | EXAMPLE | EXAMPLE | EXAMPLE | EXAMPLE |
|---|---|---|---|---|
| | 21 | 22 | 23 | 24 |
| INK | 17 | 1 | 1 | 1 |
| TREATMENT LIQUID | 1 | 5 | 1 | 1 |
| ADHESION AMOUNT OF TREATMENT LIQUID (%) (TO INK) | 10.0 | 10.0 | 10.0 | 10.0 |
| PRIMARY HEATING TEMPERATURE (° C.) | 35 | 35 | 30 | 40 |
| IMAGE QUALITY (AGGREGATION IRREGULARITY) | A | A | B | AA |
| ABRASION RESISTANCE | B | A | A | A |
| CLOGGING RECOVERY PROPERTY (INK) | AA | A | AA | B |
| LANDING DEVIATION (TREATMENT LIQUID) | A | A | AA | B |
| LANDING DEVIATION (INK) | A | A | AA | B |

| | EXAMPLE | EXAMPLE | EXAMPLE |
|---|---|---|---|
| | 25 | 26 | 27 |
| INK | 20 | 21 | 22 |
| TREATMENT LIQUID | 1 | 1 | 1 |
| ADHESION AMOUNT OF TREATMENT LIQUID (%) (TO INK) | 10.0 | 10.0 | 10.0 |
| PRIMARY HEATING TEMPERATURE (° C.) | 35 | 35 | 35 |
| IMAGE QUALITY (AGGREGATION IRREGULARITY) | AA | AA | AA |
| ABRASION RESISTANCE | C | C | C |
| CLOGGING RECOVERY PROPERTY (INK) | B | C | A |
| LANDING DEVIATION (TREATMENT LIQUID) | A | A | A |
| LANDING DEVIATION (INK) | C | C | A |

| | COMPAR- | COMPAR- | COMPAR- |
|---|---|---|---|
| | ATIVE | ATIVE | ATIVE |
| | EXAMPLE | EXAMPLE | EXAMPLE |
| | 1 | 2 | 3 |
| INK | 18 | 19 | 23 |
| TREATMENT LIQUID | 1 | 1 | 1 |
| ADHESION AMOUNT OF TREATMENT LIQUID (%) (TO INK) | 10.0 | 10.0 | 10.0 |
| PRIMARY HEATING TEMPERATURE (° C.) | 35 | 35 | 35 |
| IMAGE QUALITY (AGGREGATION IRREGULARITY) | C | C | B |
| ABRASION RESISTANCE | B | AA | D |
| CLOGGING RECOVERY PROPERTY (INK) | A | A | AA |
| LANDING DEVIATION (TREATMENT LIQUID) | A | A | A |
| LANDING DEVIATION (INK) | A | AA | AA |

### 4.6. Evaluation Result

In the ink set of each Example which was an ink set including the treatment liquid which contained the aggregating agent; and the ink composition which was a water-based ink containing the pigment dispersed by a pigment dispersant or the self-dispersible pigment, the water-dispersible resin, and the maleic acid-based resin which was a water-soluble resin, it was found that the image quality and the abrasion resistance could be simultaneously satisfied.

On the other hand, in the ink set of each Comparative Example in which the conditions described above were not satisfied, the image quality and the abrasion resistance were both inferior. In Comparative Examples 1 and 2, the ink contained no maleic acid-based resin which was a water-soluble resin, and the image quality was inferior. In Comparative Example 3, the ink contained no water-dispersible resin, and the abrasion resistance was inferior.

The embodiments and the modified examples described above are each one example, and the present disclosure is not limited thereto. For example, the embodiments and the modified examples may be appropriately used in combination.

The present disclosure includes substantially the same structure as the structure described in the embodiment. That is, the substantially the same structure includes, for example, the structure in which the function, the method, and the result are the same as those described above, or the structure in which the object and the effect are the same as those described above. In addition, the present disclosure includes the structure in which a nonessential portion of the structure described in the embodiment is replaced with something else. In addition, the present disclosure includes the structure which performs the same operational effect as that of the structure described in the embodiment or the structure which is able to achieve the same object as that of the structure described in the embodiment. In addition, the present disclosure includes the structure in which a known technique is added to the structure described in the embodiment.

From the embodiments and the modified examples described above, the following conclusions are obtained.

An ink set is an ink set comprising: a treatment liquid containing an aggregating agent; and an ink composition, and the ink composition is a water-based ink containing a pigment dispersed by a pigment dispersant or a self-dispersible pigment; a water-dispersible resin; and a maleic acid-based resin which is a water-soluble resin.

According to this ink set, since the maleic acid-based resin of the ink composition is likely to receive the function of the aggregating agent of the treatment liquid, when an image is formed by contact between the treatment liquid and the ink composition, the aggregation irregularity is not likely to be generated in the image, and hence, an image having a high image quality can be formed. Furthermore, since the ink composition contains the water-dispersible resin, degradation of the abrasion resistance of the image caused by the water soluble property of the maleic acid-based resin can be suppressed, and in addition, by the synergetic effect of the maleic acid-based resin and the water-dispersible resin, the abrasion resistance of the image can be further improved.

In the ink set described above, a content of the maleic acid-based resin with respect to a total mass of the ink composition may be 0.1 to 1.5 percent by mass.

According to this ink set, an effect of the aggregating agent of the treatment liquid is more significantly obtained, and an image having a higher image quality can be formed.

In the ink set described above, a ratio (B/A) of a content (B) of the maleic acid-based resin to a content (A) of the water-dispersible resin in the ink composition may be 0.15 or less.

According to this ink set, the abrasion resistance of an image to be formed can be made more preferable.

In the ink set described above, the maleic acid-based resin may have an aggregation property when being mixed with a calcium propionate water solution.

According to this ink set, the image quality of an image to be formed can be made more preferable.

In the ink set described above, the water-dispersible resin may have no aggregation property when being mixed with a calcium propionate water solution.

According to this ink set, even when a water-dispersible resin having no aggregation property is used, since the water-dispersible resin can be aggregated by the aggregation property of the maleic acid-based resin, an image having a sufficient abrasion resistance can be obtained.

In the ink set described above, a total mass of the water-dispersible resin and the maleic acid-based resin contained in the ink composition with respect to the total mass of the ink composition may be 0.2 to 2 percent by mass.

According to this ink set, an effect of suppressing the aggregation irregularity of an image and an effect of improving the abrasion resistance of the image can be more significantly obtained.

In the ink set described above, the maleic acid-based resin may have a carboxy group.

According to this ink set, since the aggregation property of the maleic acid-based resin can be made more preferable, the image quality of an image to be obtained can be further improved. In addition, according to this ink set, since the dissolution of the maleic acid-based resin can be further stabilized, the storage stability of the ink composition is made more preferable.

In the ink set described above, the carboxy group may be partially or fully neutralized with ammonia, an alkanolamine, or an alkylamine.

According to this ink set, since the dissolution of the maleic acid-based resin can be further stabilized, the storage stability of the ink composition is made more preferable.

In the ink set described above, the maleic acid-based resin may have a weight average molecular weight of 5,000 to 60,000.

According to this ink set, the suppression of the aggregation irregularity of an image to be obtained and the improvement in abrasion resistance can be made more preferable.

In the ink set described above, the maleic acid-based resin may have a carboxy group and an esterified carboxy group.

According to this ink set, since the balance between a hydrophilic property and a hydrophobic property of the maleic acid-based resin is made more preferable, the storage stability of the ink composition is made more preferable, and in addition, the water resistance of an image to be obtained can be improved.

In the ink set described above, the ink composition may contain the pigment dispersed by a pigment dispersant, and the pigment dispersant may include an acrylic-based resin.

According to this ink set, the dispersibility of the pigment of the ink composition can be made more preferable.

In the ink set described above, the water-dispersible resin may be one of an acrylic-based resin, an urethane-based resin, and an polyolefin-based resin, and a content of the water-dispersible resin with respect to the total mass of the ink composition may be 1 to 15 percent by mass.

According to this ink set, the abrasion resistance of an image to be obtained can be made more preferable.

In the ink set described above, the ink composition may further contain, as a water-soluble low molecular weight organic compound, a polyol having a standard boiling point of 150° C. to 250° C.

According to this ink set, the moisture retaining property of the ink composition can be further enhanced, and the clogging recovery property of a recording head can be made more preferable.

In the ink set described above, the ink composition may further contain, as a water-soluble low molecular weight organic compound, one of an amide, a sulfur-containing solvent, and a cyclic ether each having a standard boiling point of 150° C. to 300° C.

According to this ink set, since the water-soluble low molecular weight organic compound is likely to function as a solubilizing agent of the water-dispersible resin, particles of the water-dispersible resin are likely to be swelled and/or softened. Hence, the flatness of the surface of an image to be formed is further improved, and the abrasion resistance of the image can be made more preferable.

In the ink set described above, a content of the water-soluble low molecular weight organic compound with respect to the total mass of the ink composition may be 10 to 30 percent by mass.

According to this ink set, the flatness of the surface of an image to be formed is further improved, and the abrasion resistance of the image can be made more preferable.

A recording method uses one of the ink sets described above and comprises: an ink adhesion step of adhering the ink composition to a recording medium; and a treatment liquid adhesion step of adhering the treatment liquid to the recording medium.

According to this recording method, an image having a high image quality and a preferable abrasion resistance can be formed.

In the recording method described above, the ink adhesion step may be performed by an ink jet method, and the recording medium may be either a low-absorbing recording medium or a non-absorbing recording medium.

According to this recording method, even when a low-absorbing recording medium or a non-absorbing recording medium which is relatively liable to generate the aggregation irregularity is used, an image having a high image quality and a preferable abrasion resistance can be formed.

The recording method described above may further comprise: a primary heating step of heating the ink composition adhered to the recording medium.

According to this recording method, an image having a high image quality and a preferable abrasion resistance can be obtained, and in addition, an effect of a high recording rate can be more significantly obtained.

What is claimed is:

1. An ink set comprising:
a treatment liquid containing an aggregating agent; and
an ink composition,
wherein the ink composition is a water-based ink containing a pigment dispersed by a pigment dispersant or a self-dispersible pigment; a water-dispersible resin; and a maleic acid-based resin which is a water-soluble resin.

2. The ink set according to claim 1,
wherein a content of the maleic acid-based resin with respect to a total mass of the ink composition is 0.1 to 1.5 percent by mass.

3. The ink set according to claim 1,
wherein a ratio (B/A) of a content (B) of the maleic acid-based resin to a content (A) of the water-dispersible resin in the ink composition is 0.15 or less.

4. The ink set according to claim 1,
wherein the maleic acid-based resin has an aggregation property when being mixed with a calcium propionate water solution.

5. The ink set according to claim 1,
wherein the water-dispersible resin has no aggregation property when being mixed with a calcium propionate water solution.

6. The ink set according to claim 1,
wherein a total mass of the water-dispersible resin and the maleic acid-based resin contained in the ink composition with respect to a total mass of the ink composition is 0.2 to 2 percent by mass.

7. The ink set according to claim 1,
wherein the maleic acid-based resin has a carboxy group.

8. The ink set according to claim 7,
wherein the carboxy group is partially or fully neutralized with ammonia, an alkanolamine, or an alkylamine.

9. The ink set according to claim 1,
wherein the maleic acid-based resin has a weight average molecular weight of 5,000 to 60,000.

10. The ink set according to claim 1,
wherein the maleic acid-based resin has a carboxy group and an esterified carboxy group.

11. The ink set according to claim 1,
wherein the ink composition contains the pigment dispersed by a pigment dispersant, and
the pigment dispersant includes an acrylic-based resin.

12. The ink set according to claim 1,
wherein the water-dispersible resin is one of an acrylic-based resin, an urethane-based resin, and an polyolefin-based resin, and
a content of the water-dispersible resin with respect to a total mass of the ink composition is 1 to 15 percent by mass.

13. The ink set according to claim 1,
wherein the ink composition further contains, as a water-soluble low molecular weight organic compound, a polyol having a standard boiling point of 150° C. to 250° C.

14. The ink set according to claim 1,
wherein the ink composition further contains, as a water-soluble low molecular weight organic compound, one of an amide, a sulfur-containing solvent, and a cyclic ether each having a standard boiling point of 150° C. to 300° C.

15. The ink set according to claim 13,
wherein a content of the water-soluble low molecular weight organic compound contained in the ink composition with respect to a total mass of the ink composition is 10 to 30 percent by mass.

16. A recording method using the ink set according to claim 1, the method comprising:
an ink adhesion step of adhering the ink composition to a recording medium; and
a treatment liquid adhesion step of adhering the treatment liquid to the recording medium.

17. The recording method according to claim 16,
wherein the ink adhesion step is performed by an ink jet method, and
the recording medium is a low-absorbing recording medium or a non-absorbing recording medium.

18. The recording method using the ink set according to claim 16, further comprising:
a primary heating step of heating the ink composition adhered to the recording medium.
